(19) United States
(12) Patent Application Publication
(10) Pub. No.: US 2007/0140529 A1
(43) Pub. Date: Jun. 21, 2007

(54) Method and device for calculating motion vector between two images and program of calculating motion vector between two images

(75) Inventors: Hiroshi Iwabuchi, Miyagi (JP); Tetsu Wada, Miyagi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 11/641,659

(22) Filed: Dec. 20, 2006

(30) Foreign Application Priority Data
Dec. 21, 2005 (JP) P2005-368399
Jan. 12, 2006 (JP) P2006-005145
Sep. 20, 2006 (JP) P2006-254530

(51) Int. Cl. G06K 9/00

(52) U.S. Cl. 382/107

(57) ABSTRACT

A reference image is cut out from a first image and a comparison image is cut out from a second image while shifting a cutting block by n pixels and correlation between each of the comparison images. The reference image is calculated to obtain a motion vector of the second image with respect to the first image. Plural second images (hereinafter, referred to as 2-1 image, 2-2 image, . . . ) obtained by shifting the second image by m pixels (m<n) are created and stored in a memory. Also, when cutting out the comparison image, plural comparison images are cut out from each of the 2-1 image, 2-2 image, . . . and operations of calculating correlation between each of the comparison images and the reference image are performed in parallel.

### BACKGROUND OF THE INVENTION

1. Technical Field

The invention relates to a method and device for calculating a motion vector between two images in order to detect a motion vector (amount of movement and direction of movement) and a program of calculating a motion vector between two images.

2. Description of the Related Art

In the case of shooting motion pictures while holding, for example, a video camera or a digital still camera having a video recording function with a hand, if the hand holding the camera jiggles, the position of an image of a still object included in an image of a certain frame will move in an image of the next frame, which prevents the image from being clearly distinguished. For this reason, a motion vector of an image of the next frame with respect to an image of the certain frame is detected so as to compensate for the camera shape so that images are not blurred.

FIGS. 12A and 12B are views explaining a principle of detecting a motion vector to compensate for camera shake. It is assumed that an image within a block 2 which is indicated by a predetermined address and which is included in an image 1 of an Nth frame shown in FIG. 12A is a reference image. If an image cut out by a block 4 which is indicated by the same predetermined address and which is included in an image 3 of an (N +1)th frame is identical with the reference image, the image 3 does not shake with respect to the image 1.

However, if hand jiggles, the reference image within the block 2 does not match the image cut out by the block 4. Then, while shifting the block 4 within the image 3 to blocks 4a, 4b, 4c, . . . , by one pixel in the X direction (horizontal direction) and the Y direction (vertical direction), an image within each of the blocks 4a, 4b, 4c, . . . is compared with the reference image, and the position of a block from which a comparison image having the highest correlation with respect to the reference image is cut out is obtained.

In the example shown in FIG. 12B, it is assumed that a comparison image having the highest correlation with respect to the reference image within the block 2 is cut out by the block c. In this case, a difference between the image 1 and the image 3 is ‘k’. The ‘k’ represents a motion vector between two images. In addition, by displaying the image 1 and then displaying the image 3 after moving the image 3 by the motion vector ‘k’ in the opposite direction, an image from which the camera shake has been eliminated can be displayed.

An operation of calculating the correlation between the reference image and the comparison image is performed by comparing each pixel of the reference image with the corresponding pixel of the comparison image and then calculating a minimum value of a total sum of all pixel differences within the block. Therefore, an operation load is large and time required for the operation is also long. As a result, the calculating of the motion vector may not be completed until a next frame is displayed. Therefore, by shifting the blocks 4a, 4b, 4c, . . . by eight pixels not by one pixel, it is possible to reduce the load of the operation process and to shorten the operation time.

For example, JP 2003-331292 A, JP 2004-146995 A and JP 2005-228273 A are relevant to the camera shake compensation.

As described above, if the cutting block for the comparison image, which is to be compared with the reference image, is shifted within a frame by plural pixels (e.g. eight pixels) in order to detect a motion vector between two images caused by, for example, the hand jiggling, it is possible to reduce the operation load and to shorten the operation time.

However, the shifting of the cutting block by eight pixels means that a minimum detection unit (resolution) of an amount of movement is quantized by eight pixels in both the X direction and the Y direction, as shown in FIG. 13. Thus, a quantization error occurs. That is, since the resolution of the amount of movement cannot be set below eight pixels, camera shake between two images cannot be suppressed below eight pixels.

### SUMMARY OF THE INVENTION

The invention provides a method and device for calculating a motion vector between two images and a program of calculating a motion vector between two images, which can set resolution of a motion vector (amount of movement and direction of movement) to be below a shift unit of a cutting block in the case where the shift unit of the cutting block for a comparison image is plural pixels.

According to an aspect of the invention, a method of calculating a motion vector between two images includes: cutting out a reference image from a first image with a reference image cutting block; shifting a second image by m pixels and storing a plurality of the shifted second images in a memory; cutting out comparison images from the shifted second images while shifting a comparison image cutting block by n pixels wherein 2≦n, m<n and the comparison image cutting block has the same size as the reference image cutting block; performing operations of calculating correlations between the reference image and the respective comparison images cut out from the respective shifted second images in parallel; and calculating a motion vector of the second image with respect to the first image based on a position of the comparison image cutting block, from which a comparison image having the highest correlation to the reference image is cut out, and a position of the reference image cutting block.

According to another aspect of the invention, a method of calculating a motion vector between two images includes: dividing a first image into a predetermined number of first partial images; dividing a second image into second partial images wherein number of the second partial images is equal to the predetermined number, and the first partial images are equal in size to the second partial images; shifting the plurality of second partial images by different numbers of pixels wherein the different numbers are smaller than n; storing the shifted second partial images in a memory; cutting out a reference image from each of the first partial images with reference image cutting blocks; cutting out a plurality of comparison images from the shifted second partial images with comparison image cutting blocks while shifting the comparison image cutting blocks by n pixels wherein the comparison image cutting blocks are equal in size to the reference image cutting blocks; calculating correlations between the plurality of comparison images, which are cut out from the shifted second partial images, and the reference images cut out from the corresponding first partial images, calculating a motion vector of each of the second partial images with respect to the corresponding first partial image based on a position of the comparison image cutting block, from which a comparison image having the highest correlation to the reference image is cut out, and the position of the reference image cutting block; and calculating a motion vector of the second image with respect to the first image based on the motion vectors of the plurality of second partial images.

The method may further include: shifting the plurality of first partial images by different numbers of pixels wherein the different numbers are smaller than n; and storing the shifted first partial images in a memory. The cutting of the reference image from each first partial image may cut out the reference image from each shifted first partial images.

Also, the calculating of the motion vector of the second image with respect to the first image may include: excluding a motion vector showing an abnormal value from the motion vectors of the plurality of second partial images; and weight-averaging the motion vectors of the remaining second partial images.

Also, the method may further include: acquiring the first image and the second image subsequently as successive frame images; and after the motion vector of the second image with respect to the first image is calculated, when a third image is acquired as a next frame, cutting out the reference image from the second image with the cutting block; shifting the third image by m pixels and storing a plurality of the shifted second images in the memory; cutting out the comparison images from the shifted third images while shifting the comparison image cutting block by n pixels; performing operations of calculating correlations between the reference image and the respective comparison images cut out from the respective shifted third images in parallel; and calculating a motion vector of the third image with respect to the second image based on a position of the comparison image cutting block, from which a comparison image having the highest correlation to the reference image is cut out, and a position of the reference image cutting block.

Also, the method may further include reducing the plurality of shifted second images at a predetermined magnification in at least one of a vertical direction and a horizontal direction. The storing of the shifted second images may store the reduced second images in the memory. The cutting out of the comparison images may cut out the comparison images from the reduced second images while shifting the comparison image cutting block, which is reduced at the predetermined magnification, by one pixel. The cutting out of the reference image may cut out the reference image from the first image, which is reduced at the predetermined magnification.

Also, the reducing of the shifted second images may reduce the plurality of shifted second images to 1/n in the vertical and horizontal directions.

According to further another aspect of the invention, an apparatus for calculating a motion vector between two images includes a reference image cutting circuit, a comparison image cutting circuit, a comparison operation circuit and a movement amount operation circuit. The reference image cutting circuit cuts out a reference image from a first image with a reference image cutting block. The comparison image cutting circuit cuts out comparison images from shifted second images, which are obtained by shifting a second image by m pixels, while shifting a comparison image cutting block by n pixels wherein 2≦n, m<n and the comparison image cutting block has the same size as the reference image cutting block. The comparison operation circuit performs operations of calculating correlations between the reference image and the respective comparison images cut out from the respective shifted second images in parallel. The movement amount operation circuit calculates a motion vector of the second image with respect to the first image based on a position of the comparison image cutting block, from which a comparison image having the highest correlation to the reference image is cut out, and a position of the reference image cutting block.

According to still another aspect of the invention, an apparatus for calculating a motion vector between two images includes a first shifting circuit, a second shifting circuit, a memory, a first cutting circuit, a second cutting circuit, a first operator and a second operator. The first shifting circuit divides a first image into a predetermined number of first partial images. The second shifting circuit divides a second image into second partial images and shifts the plurality of second partial images by different numbers of pixels. Number of the second partial images is equal to the predetermined number. The first partial images are equal in size to the second partial images. The different numbers are smaller than n. The memory stores the shifted second partial images. The first cutting circuit cuts out a reference image from each of the first partial images with a reference image cutting block. The second cutting circuit cuts out a plurality of comparison images from the shifted second partial images with comparison image cutting blocks while shifting the comparison image cutting blocks by n pixels. The comparison image cutting blocks are equal in size to the reference image cutting blocks. The first operator calculates correlations between the plurality of comparison images, which are cut out from the shifted second partial images, and the reference images cut out from the corresponding first partial images. The first operator calculates a motion vector of each of the second partial images with respect to the corresponding first partial image based on a position of the comparison image cutting block, from which a comparison image having the highest correlation to the reference image is cut out, and the position of the reference image cutting block. The second operator calculates a motion vector of the second image with respect to the first image based on the motion vectors of the plurality of second partial images.

Also, the first shifting circuit may shift the plurality of first partial images by different number of pixels. The different numbers are smaller than n. The apparatus may further include another memory that stores the shifted first partial images. The first cutting block may cut out the reference image from each of the shifted first partial images.

Also, the second operator may exclude a motion vector showing an abnormal value from the motion vectors of the plurality of second partial images and weight-average the motion vectors of the remaining second partial images to calculate the motion vector of the second image with respect to the first image.

Also, after the first and second images are subsequently input to the apparatus as successive frame images and the movement amount operation circuit calculates the motion vector of the second image with respect to the first image, when a third image is input to the apparatus as a next frame image, the reference image cutting circuit may cut out the reference image from the second image with the reference image cutting block. Then, the comparison image cutting circuit may cut out comparison images from shifted third images, which are obtained by shifting third image by m pixels, while shifting the comparison image cutting block by n pixels. The comparison operation circuit may perform operations of calculating correlations between the reference image and the respective comparison images cut out from the respective shifted third images in parallel. The movement amount operation circuit may calculate a motion vector of the third image with respect to the second image based on a position of the comparison image cutting block, from which a comparison image having the highest correlation to the reference image is cut out, and a position of the reference image cutting block.

Also, the apparatus may further include a pixel thinning-out circuit that reduces the plurality of shifted second images at a predetermined magnification in at least one of a vertical direction and a horizontal direction. The reduced second images may be stored in a memory. The comparison image cutting circuit may cut out the comparison images from the reduced second images while shifting the comparison image cutting block, which is reduced at the predetermined magnification, by one pixel. The reference image cutting circuit may cut out the reference image from the first image, which is reduced at the predetermined magnification.

Also, the pixel thinning-out circuit may reduce the plurality of shifted second images to 1/n in the vertical and horizontal directions.

According to still further another aspect of the invention, a computer-readable medium stores a program causing a computer to execute a process for calculating a motion vector between two images. The process includes: cutting out a reference image from a first image with a reference image cutting block; shifting a second image by m pixels and storing a plurality of the shifted second images in a memory; cutting out comparison images from the shifted second images while shifting a comparison image cutting block by n pixels wherein 2≦n, m<n and the comparison image cutting block has the same size as the reference image cutting block; performing operations of calculating correlations between the reference image and the respective comparison images cut out from the respective shifted second images in parallel; and calculating a motion vector of the second image with respect to the first image based on a position of the comparison image cutting block, from which a comparison image having the highest correlation to the reference image is cut out, and a position of the reference image cutting block.

According to still further another aspect of the invention, a computer-readable medium stores a program causing a computer to execute a process for calculating a motion vector between two images. The process includes: dividing a first image into a predetermined number of first partial images; dividing a second image into second partial images wherein number of the second partial images is equal to the predetermined number, and the first partial images are equal in size to the second partial images; shifting the plurality of second partial images by different numbers of pixels wherein the different numbers are smaller than n; storing the shifted second partial images in a memory; cutting out a reference image from each of the first partial images with reference image cutting blocks; cutting out a plurality of comparison images from the shifted second partial images with comparison image cutting blocks while shifting the comparison image cutting blocks by n pixels wherein the comparison image cutting blocks are equal in size to the reference image cutting blocks; calculating correlations between the plurality of comparison images, which are cut out from the shifted second partial images, and the reference images cut out from the corresponding first partial images; calculating a motion vector of each of the second partial images with respect to the corresponding first partial image based on a position of the comparison image cutting block, from which a comparison image having the highest correlation to the reference image is cut out, and the position of the reference image cutting block; and calculating a motion vector of the second image with respect to the first image based on the motion vectors of the plurality of second partial images.

Also, the process may further include: shifting the plurality of first partial images by different numbers of pixels wherein the different numbers are smaller than n; and storing the shifted first partial images in a memory. The cutting of the reference image from each first partial image may cut out the reference image from each shifted first partial images.

Also, the calculating of the motion vector of the second image with respect to the first image may include: excluding a motion vector showing an abnormal value from the motion vectors of the plurality of second partial images; and weight-averaging the motion vectors of the remaining second partial images.

Also, the process further include: acquiring the first image and the second image subsequently as successive frame images; and after the motion vector of the second image with respect to the first image is calculated, when a third image is acquired as a next frame, cutting out the reference image from the second image with the cutting block; shifting the third image by m pixels and storing a plurality of the shifted second images in the memory; cutting out the comparison images from the shifted third images while shifting the comparison image cutting block by n pixels; performing operations of calculating correlations between the reference image and the respective comparison images cut out from the respective shifted third images in parallel; and calculating a motion vector of the third image with respect to the second image based on a position of the comparison image cutting block, from which a comparison image having the highest correlation to the reference image is cut out, and a position of the reference image cutting block.

Also, the process may further include reducing the plurality of shifted second images at a predetermined magnification in at least one of a vertical direction and a horizontal direction. The storing of the shifted second images may store the reduced second images in the memory. The cutting out of the comparison images may cut out the comparison images from the reduced second images while shifting the comparison image cutting block, which is reduced at the predetermined magnification, by one pixel. The cutting out of the reference image may cut out the reference image from the first image, which is reduced at the predetermined magnification.

Also, the reducing of the shifted second images may reduce the plurality of shifted second images to 1/n in the vertical and horizontal directions.

According to still further another aspect, a motion detection method include: cutting out a part of a first image as a reference image; dividing the cut reference image into a plurality of partial reference regions; cutting out a part of a second image as a comparison image, wherein the reference image is equal in size to the comparison image; dividing the comparison image into a plurality of partial comparison regions, wherein the number of the partial reference regions is equal to the number of the partial comparison regions; cutting out a partial reference image from each partial reference region with a partial reference image cutting block; cutting out partial comparison images from each partial comparison region with a partial comparison image cutting block while shifting the partial comparison image cutting block by n pixels, wherein the partial reference image cutting blocks are equal in size to the partial comparison image cutting blocks; calculating correlations between each partial reference image and the corresponding partial comparison images; calculating a motion vector of each partial comparison region with respect to the corresponding partial reference region based on a position of the partial comparison image cutting block, from which a partial comparison image having the highest correlation to the corresponding partial reference image is cut out, and a position of the partial reference image cutting block; and calculating a motion vector of the second image with respect to the first image based on the plurality of calculated motion vectors of the partial comparison regions with respect to the respective partial reference regions.

Also, the method may further include: shifting the first image by different numbers of pixels and storing a plurality of the shifted first images in a memory. The different numbers may be smaller than n. The plurality of partial reference images may be cut out from the respective shifted first images.

The method may further include: shifting the second image by different numbers of pixels and storing a plurality of the shifted second images in a memory. The different numbers may be smaller than n. The plurality of partial comparison images may be cut out from the respective shifted second images.

Also, a pixel shifting pattern of each partial comparison image may be an organized dither pattern.

Also, the method may further include: reducing the second image at a predetermined magnification in at least one of a vertical direction and a horizontal direction; and storing the reduced second images in a memory. The comparison image or the partial comparison images may be cut out with shifting by one-pixel on the reduced second image.

Also, the reducing of the second image may reduce the second image to 1/n in the vertical and horizontal directions.

According to still further another aspect of the invention, a motion detection apparatus includes a reference image cutting circuit, a comparison image cutting circuit, a first operator and a second operator. The reference image cutting circuit cuts out a part of a first image as a reference image. The reference image cutting circuit divides the cut reference image into a plurality of partial reference regions. The reference image cutting circuit cuts out a partial reference image from each partial reference region with a partial reference image cutting block. The comparison image cutting circuit cuts out a part of a second image as a comparison image. The comparison image cutting circuit divides the comparison image into a plurality of partial comparison regions. The comparison image cutting circuit cuts out partial comparison images from each partial comparison region with a partial comparison image cutting block while shifting the partial comparison image cutting block by n pixels. The reference image is equal in size to the comparison image. The number of the partial reference regions is equal to the number of the partial comparison regions. The partial reference image cutting blocks are equal in size to the partial comparison image cutting blocks. The first operator calculates correlations between each partial reference image and the corresponding partial comparison images. The first operator calculates a motion vector of each partial comparison region with respect to the corresponding partial reference region based on a position of the partial comparison image cutting block, from which a partial comparison image having the highest correlation to the corresponding partial reference image is cut out, and a position of the partial reference image cutting block. The second operator calculates a motion vector of the second image with respect to the first image based on the plurality of calculated motion vectors of the partial comparison regions with respect to the respective partial reference regions.

Also, the apparatus may further include a first shifting circuit and a first memory. The first shifting circuit shifts the first image by different numbers of pixels. The first memory stores a plurality of the shifted first images. The different numbers may smaller than n. The plurality of partial reference images may be cut out from the respective shifted first images.

Also, the apparatus may further include a second shifting circuit and a second memory. The second shifting circuit shifts the second image by different numbers of pixels. The second memory stores a plurality of the shifted second images. The different numbers may be smaller than n. The plurality of partial comparison images may be cut out from the respective shifted second images.

Also, a pixel shifting pattern of each partial comparison image may be an organized dither pattern.

Also, the apparatus may further include a pixel thinning-out circuit and a memory. The pixel thinning-out circuit reduces the second image at a predetermined magnification in at least one of a vertical direction and a horizontal direction. The memory stores the reduced second images. The comparison image and the partial comparison images may be cut out with shifting by one-pixel on the reduced second image.

Also, the pixel thinning-out circuit may reduce the second image to 1/n in the vertical and horizontal directions.

According to the above configuration, comparison images are cut out from plural second images obtained by shifting pixels and compared with the reference image to thereby obtain the correlation between the comparison images and the reference image with a parallel process. Therefore, it is possible to obtain a motion vector having high resolution at a high speed.

### BRIEF DESCRIPTION OF THE DRAWINGS

FIG. 1 is a view illustrating the configuration of an apparatus for calculating a motion vector between two images according to a first embodiment of the invention.

FIG. 2 is a view explaining a principle of the first embodiment of the invention.

FIG. 3 is a view explaining increase of resolution according to a second embodiment of the invention.

FIG. 4 is a view illustrating the functional configuration of an apparatus for calculating a motion vector between two images according to the second embodiment of the invention.

FIG. 5 is a view illustrating an example of dividing a frame into sixteen (=4×4) partial regions, which are operated in the second embodiment of the invention.

FIG. 6 is a view explaining a principle of the second embodiment of the invention.

FIG. 7 is a view illustrating an amount of pixel shifting and a direction of pixel shifting of each of sixteen partial regions of an image of an Nth frame according to the second embodiment of the invention.

FIG. 8 is a view illustrating an amount of pixel shifting and a direction of pixel shifting of each of sixteen partial regions of an image of an (N+1)th frame according to the second embodiment of the invention.

FIGS. 9A and 9B are views explaining a principle of calculating a motion vector between images from the motion vectors of the sixteen partial regions according to the second embodiment of the invention.

FIG. 10 is a flow chart illustrating a processing sequence of a program of calculating a motion vector according to a third embodiment of the invention.

FIG. 11 is a flow chart illustrating a processing sequence of a program of calculating a motion vector according to a fourth embodiment of the invention.

FIGS. 12A and 12B are views explaining a typical method of detecting camera shake according to the related art.

FIG. 13 is a view explaining resolution at the time of typical detection of camera shake according to the related art.

FIG. 14 is a view illustrating the functional configuration of a motion detection apparatus according to a fifth embodiment of the invention.

FIGS. 15A and 15B are views illustrating an example of a region of a reference image and a region of a comparison image according to the fifth embodiment of the invention.

FIG. 16 is a view illustrating an example of dividing into sixteen (=4×4) divided regions, which are operated in the fifth embodiment of the invention.

FIG. 17 is a view explaining a principle of the fifth embodiment of the invention.

FIG. 18 is a view illustrating images which are obtained by pixel shifting and which are used in the respective divided regions of the image of the Nth frame according to the fifth embodiment of the invention.

FIG. 19 is a view illustrating images which are obtained by pixel shifting and which are used in the respective divided regions of the image of an (N+1)th frame according to the fifth embodiment of the invention.

FIG. 20 is a view illustrating an example of division and an amount of pixel shifting according to a sixth embodiment of the invention.

### DETAILED DESCRIPTION OF EXEMPLARY EMBODIMENTS

Hereinafter, embodiments of the invention will be described with reference to the accompanying drawings.

### First Embodiment

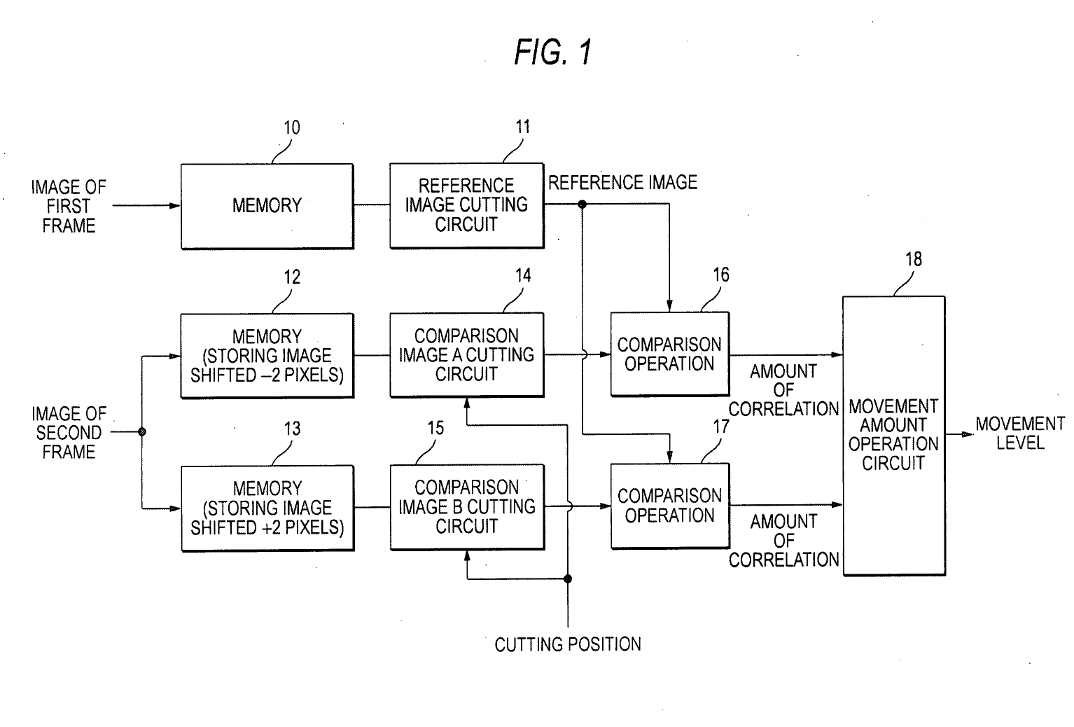

FIG. 1 is a view illustrating the configuration of an apparatus for calculating a motion vector between two images according to the first embodiment of the invention. A shift unit of a block from which a comparison image is cut out is n-th power of 2 (n is desired number). For the purpose of clear explanation, it is assumed that the shift unit is eight pixels in the following description.

Referring to FIG. 1, a motion vector calculating apparatus according to the first embodiment includes a memory 10 that receives and stores an image of a first frame, a reference image cutting circuit 11 that cuts out a reference image located at a predetermined address from the data stored in the memory 10, a memory 12 that receives an image of a second frame to be compared with the first frame and stores the image of the second frame with shifting the image of the second frame −2 pixels, and a memory 13 that receives the image of the second frame and stores the image of the second frame with shifting the image of the second frame +2 pixels.

The motion vector calculating apparatus according to the first embodiment includes an cutting circuit 14 that cuts out a comparison image A located at a specified block position from the data stored in the memory 12, a cutting circuit 15 that cuts out a comparison image B located at the specified block position from the data stored in the memory 13, a comparison operation circuit 16 that performs a comparison operation between the comparison image A and the reference image so as to calculate a correlation amount between the comparison image A and the reference image, a comparison operation circuit 17 that performs a comparison operation between the comparison image B and the reference image so as to calculate a correlation amount between the comparison image B and the reference image, and a movement amount operation circuit 18 that receives the correlation amounts output from the comparison operation circuit 16 and from the comparison operation circuit 17 so as to obtain a motion vector of the second frame with respect to the first frame.

In the motion vector calculating apparatus described above, the image of the first frame is input to the memory 10 and is then stored in the memory 10. The cutting circuit 11 cuts out the reference image from the image data stored in the memory 10 by means of a block located at the predetermined address. Then, the cutting circuit 11 outputs the reference image to the comparison operation circuits 16 and 17.

Then, the image of the second frame to be compared with the first frame is input to the two memories 12 and 13 and is then stored in parallel in the memories 12 and 13. The input image is stored in the memory 12 while being shifted −2 pixels in the horizontal direction. The input image is stored in the memory 13 while being shifted +2 pixels in the horizontal direction.

The cutting circuit 14 cuts out the data stored in the memory 12 and then outputs the cutout data to the comparison operation circuit 16. The cutting circuit 15 cuts out the data stored in the memory 13 and then outputs the cutout data to the comparison operation circuit 17. Both the cutting circuits 14 and 15 cut out the comparison images from the same specified cutting position (block).

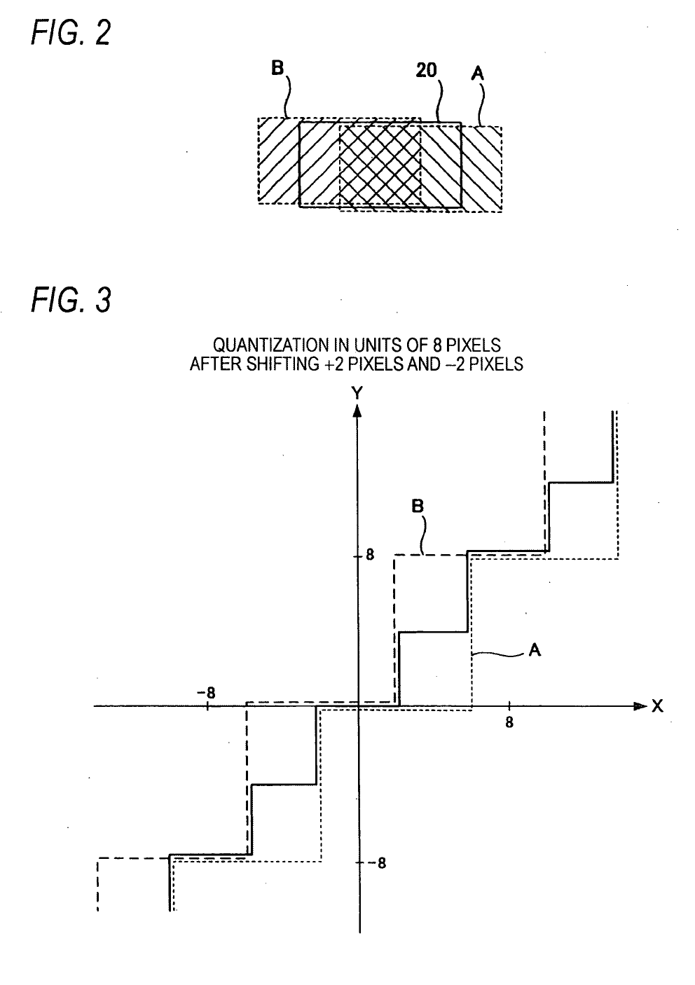

The cutting circuit 14 cuts out the image data of the memory 13 by means of a cutting block 20 as shown in FIG. 2. At this time, since the image data stored in the memory 13 is shifted by −2 pixels in the X direction in advance, the comparison image A actually cut out becomes an image shifted +2 pixels from the position of the specified block 20 on the original image. In the same manner, the comparison image B cut out by the cutting circuit 15 becomes an image shifted −2 pixels from the position of the specified block 20 on the original image.

The comparison operation circuit 16 calculates the correlation amount between the reference image and the comparison image A, and the comparison operation circuit 17 calculates the correlation amount between the reference image and the comparison image B. Both the comparison operations are performed in parallel. The cutting circuits 14 and 15 cut out the comparison images A and B located at the specified block, which is sequentially shifted by eight pixels. The comparison operation circuits 16 and 17 calculate the correlation amounts at the respective block positions. In addition, the movement amount operation circuit 18 receives a result obtained by calculating the plural correlation amounts output from the comparison operation circuits 16 and 17, calculates a motion vector of the second frame with respect to the first frame, and then outputs the calculated motion vector.

As described above, in the first embodiment, the position of the comparison image cutting block 20 is shifted by eight pixels. However, in actuality, in order to compare the comparison images A and B relatively shifted by four pixels with the reference image, the quantization of a movement amount is performed in the unit of four pixels as shown in FIG. 3. That is, the comparison images A and B, which are shifted from each other four pixels, are shifted by eight pixels. As a result, the resolution of an amount of movement is four pixels.

In the first embodiment described above, the comparison images have been shifted −2 pixels and +2 pixels only in the horizontal direction, respectively, for the convenience of explanation. However, in order to increase the resolution in the Y direction, the comparison images may be shifted −2 pixels and +2 pixels in the vertical direction, respectively, and other memories, other cutting circuits and another comparison operation circuit corresponding thereto may be provided. Although this may be performed in a software manner, hardware may be used in order to shorten processing time.

### Second Embodiment

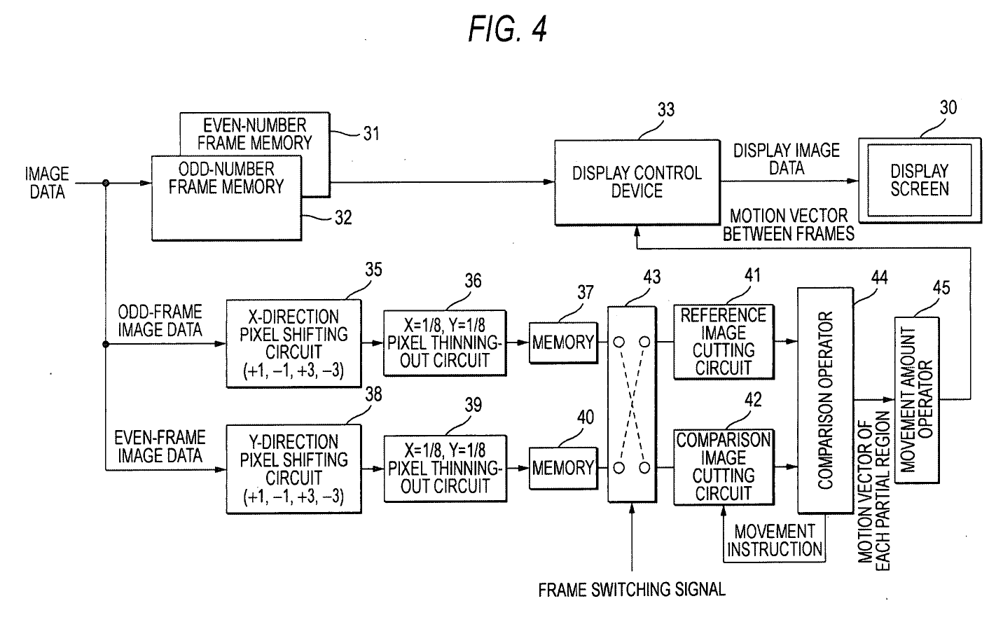

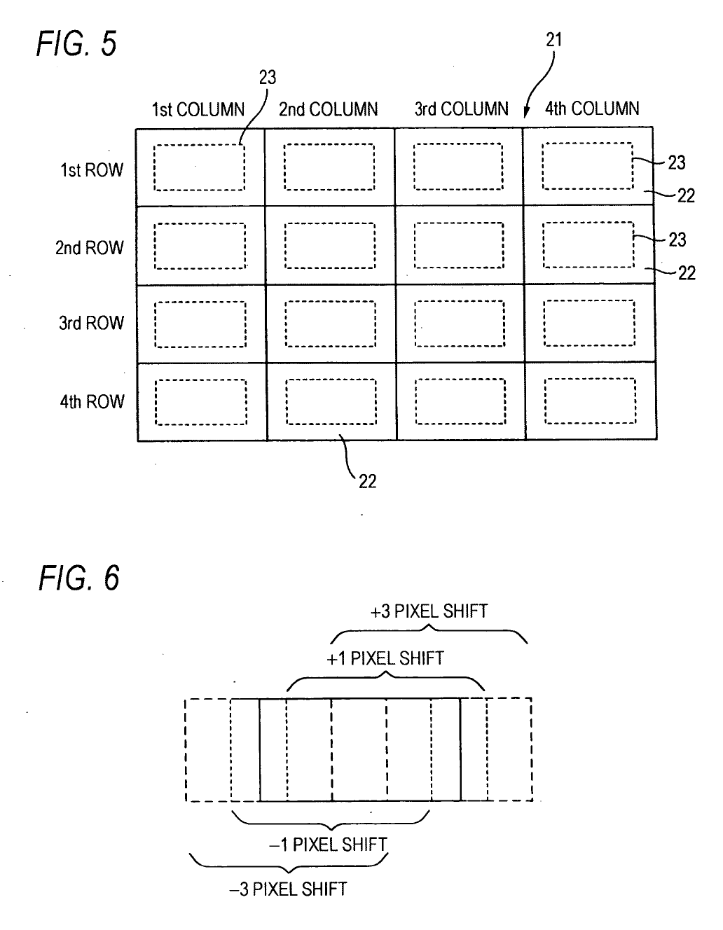

FIG. 4 is a view illustrating the configuration of an apparatus for calculating a motion vector between two images according to a second embodiment of the invention. Prior to describing the second embodiment shown in FIG. 4, a principle of calculating a motion vector according to the second embodiment will be explained with reference to FIGS. 5 to 8.

In the first embodiment, a big block is set on the first frame and the comparison operation between the reference image within the set block and the comparison image within a block of the second from is performed to obtain the motion vector. However, in the case where a part of an image within a block moves significantly, for example, if a motion picture in which an animal runs has been captured, camera shake of the entire image and movement of the animal captured in a part of the image cannot be distinguished. Accordingly, since the movement of the animal may increase a calculation error of a camera shake motion vector of the entire image.

Therefore, in the second embodiment, a frame is divided into plural regions and a block is set within each of the divided regions (partial regions). For example, as shown in FIG. 5, a frame 21 is divided into sixteen (=4×4) partial regions 22 and a block 23 is set within each of the partial regions 22. In addition, a comparison image is cut out while the block 23 is being moved within the partial region 22 (that is, a search range using each of the blocks 23 is set within the corresponding partial region 22 to which each of the blocks 23 belongs) and a motion vector corresponding to each partial region 22 is calculated.

That is, in the second embodiment shown in FIG. 5, sixteen motion vectors are calculated and a motion vector of the entire frame is obtained based on the sixteen motion vectors. A camera shake motion vector of the entire frame should be equal to the motion vector in each of the sixteen partial regions. However, if an animal moves around in some of the partial regions, only motion vectors corresponding to the some of the partial regions show abnormal values as compared with motion vectors of the other partial regions. Accordingly, by using the other motion vectors excluding the motion vectors showing the abnormal values, it is possible to calculate the motion vector of the entire frame with high precision.

Further, in the first embodiment, the comparison image cutting block is shifted by eight pixels, an image shifted −2 pixels and an image shifted +2 pixels are stored in the memories, and the resolution of a motion vector that needs to be obtained is four pixels. When images are shifted −1 pixel, −3 pixels, +1 pixel and +3 pixels in the horizontal direction by the use of the method described above, the resolution in the horizontal direction can be two pixels as shown in FIG. 6. In the same manner, although not shown, when images are shifted −1 pixel, −3 pixels, +1 pixel and +3 pixels in the vertical direction, the resolution in the vertical direction can be two pixels. The second embodiment calculates a motion vector having resolution of two pixels in both the vertical direction and the horizontal direction.

In the second embodiment, since it is necessary to calculate a motion vector between two images, that is, one motion vector, a configuration is used in which a motion vector having resolution of two pixels is calculated at a high speed. The principle will be described below.

As described above, in order to set the resolution to be two pixels, it is necessary to store in a memory images shifted −1 pixel, −3 pixels, +1 pixel and +3 pixels in both the horizontal and vertical directions. In addition, it is possible to calculate a motion vector having the resolution of two pixels by performing a comparison operation between a reference image and comparison images obtained by the pixel shifting.

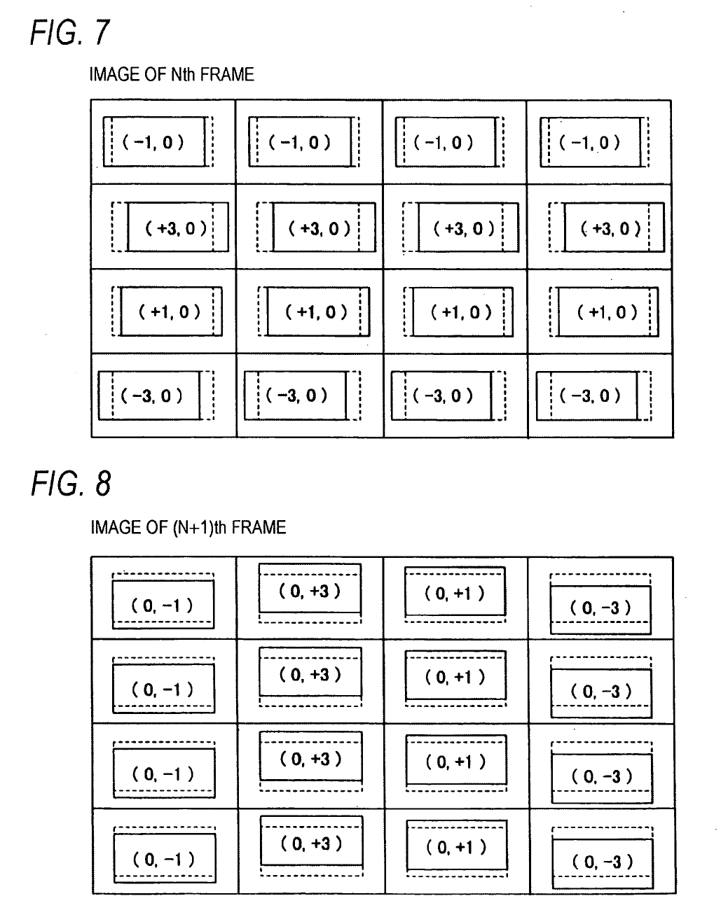

Even though the method described above may be applied to each of the sixteen partial regions shown in FIG. 5, the operation time is long. Accordingly, a method shown in FIGS. 7 and 8 is adopted.

FIG. 7 illustrates an image of an Nth frame, and FIG. 8 illustrates an image of an (N+1)th frame. In the same manner as in FIG. 5, each of the frames shown in FIGS. 7 and 8 is divided into sixteen (=4×4) partial regions.

Since image data is input while being horizontally scanned, image data of four partial regions located at a first row (see FIG. 5) is first stored in the memory. At this time, in the case of the image of the Nth frame, input image data of partial regions located at the first row are stored in the memory while the image data are shifted −1 pixel in the X direction, as shown in FIG. 7. Then, second-row input image data are stored in the memory while the image data are shifted +3 pixels in the X direction, third-row input image data are stored in the memory while the image data are shifted +1 pixel in the X direction, and fourth-row input image data is stored in the memory while the image data are shifted −3 pixels in the X direction.

Next, input image data of the (N+1)th frame is stored in a memory as shown in FIG. 8. That is, input image data of a partial region located at a first row and a first column is stored in the memory while the image data is shifted −1 pixel in the Y direction, input image data of a partial region located at the first row and a second column is stored in the memory while the image data is shifted +1 pixels in the Y direction, input image data of a partial region located at the first row and a third column is stored in the memory while the image data is shifted +1 pixel in the Y direction, and input image data of a partial region located at the first row and a fourth column is stored in the memory while the image data is shifted −3 pixels in the Y direction. In the same manner as described above, image data of partial regions located at second, third and fourth rows are stored in the memory, respectively. Thus, the image data of the partial regions located at the first, second, third and fourth columns become images shifted −1 pixel, +3 pixels, +1 pixel and −3 pixels in the Y direction, respectively.

In the case of using the image shown in FIG. 7 as a reference image, for example, a reference image is cut out from a central block (block shown by a dotted line) within the partial region located at the first row and the first column shown in FIG. 7 and a comparison image to be compared with the reference image is cut out from a cutting block (block shown by the dotted line) located at a central part within the partial region at the first row and the first column shown in FIG. 8. Then, a comparison operation between the reference image and the comparison image is performed. After the comparison operation, the cutting block is shifted eight pixels in the horizontal or vertical direction and then the comparison operation between the reference image and the comparison image again. Furthermore, the process of shifting the cutting block eight pixels and performing the comparison operation is repeated. Then, the position of a cutting block from which the highest correlation to the reference image is obtained, and a motion vector in the partial region located at the first row and the first column is obtained.

For the partial region located at the first row and the second column, the comparison operation is performed in the same manner as described above so as to obtain a motion vector in the partial region located at the first row and the second column. In this manner, a motion vector of each of the sixteen motion regions is obtained. Then, a motion vector of the entire frame is calculated after obtaining the sixteen motion vectors.

The motion vector of each partial region calculated as described above has only resolution of eight pixels. However, comparison images in the respective partial regions are slightly shifted. Therefore, by averaging the motion vectors obtained for the sixteen partial regions so as to calculate the motion vector between the frames, the resolution of the motion vector between the frames is two pixels.

After calculating the motion vector of the image of the (N+1)th frame with respect to the image of the Nth frame, a motion vector of an image of an (N+2)th frame with respect to the image of the (N+1)th frame is calculated in the same manner as described above. In this case, the frame shown in FIG. 8 becomes a frame from which reference images are cut out, and the frame shown in FIG. 7 becomes a frame from which comparison images are cut out.

The apparatus for calculating a motion vector between two images according to the second embodiment, which is configured on the basis of the principle described above, may be mounted in a digital still camera having a video recording function, for example, as shown in FIG. 4.

The digital still camera includes a display device 30, two frame memories 31 and 32 that store captured image data while alternately rewriting an even-number frame image and an odd-number frame image of the captured image data, and a display control device 33 that make a control such that the image data stored in the frame memories 31 and 32 is read out and that the read image data is displayed on the display device 30.

The motion vector calculating apparatus, which is mounted in the digital still camera shown in FIG. 4, according to the second embodiment acquires the input image data stored in the frame memories 31 and 32 in parallel, calculates a motion vector between an image of an (N+1)th frame with respect to an image of an Nth frame, and outputs the calculated motion vector between the frames (images) to the display control device 33.

The motion vector calculating apparatus includes a pixel shifting circuit 35 that is input with the image data of an odd-number frame and then performs pixel shifting (the above pixel shifting of −1, +3, +1 and −3 pixels) in the X direction, a pixel thinning-out circuit 36 that reduces the image data output from the pixel shifting circuit 35 to ⅛ (reduces 64 (=8×8) pixels to one pixel) in both the X and Y directions, and a memory 37 that stores pixel-thinned image data of the odd-number frame.

In addition, the motion vector calculating apparatus includes a pixel shifting circuit 38 that is input with the image data of an even-number frame and then performs pixel shifting (the above pixel shifting of −1, +3, +1 and −3 pixels) in the Y direction, a pixel thinning-out circuit 39 that reduces the image data output from the pixel shifting circuit 38 to ⅛ (reduces 64 (=8×8) pixels to one pixel) in both the X and Y directions, and a memory 40 that stores pixel-thinned image data of the even-number frame.

In the second embodiment, the pixel thinning-out circuits 36 and 39 are provided so as to thin out the pixels to ⅛ in the X and Y directions. Moving the cutting block on an original image by eight pixels corresponds to moving the cutting block on a reduced image by one pixel. In addition, reduced images are used as both the comparison image and the reference image. Accordingly, it is possible to reduce a load in the comparison operation performed on each pixel, to shorten the processing time, and to reduce the capacity of the memories 37 and 39. Here, the reduction in the vertical and horizontal directions is not necessarily performed at the same magnification. The reduction may be performed in only the vertical direction or in only the horizontal direction.

Further, the motion vector calculating apparatus includes: a reference image cutting circuit 41 that cuts out a reference image by means of a block having a predetermined address; a comparison image cutting circuit 42 that cuts out a comparison image by means of the cutting block; a switch circuit 43 that switches connection between the memories 37 and 40 and the cutting circuits 41 and 42 based on a frame switching signal; a comparison operator 44 that performs a comparison operation between the reference image and the comparison image so as to calculate a motion vector of each partial region (which will be described later) after receiving the image data output from the cutting circuits 41 and 42 and outputs to the comparison image cutting circuit 42 a command for shifting the cutting position of the cutting block; and a movement amount operator 45 that calculates a motion vector between frames from the motion vectors of the respectively partial regions and outputs the calculated motion vector to the display control device 33.

In the motion vector calculating apparatus having the configuration described above, when an image of an Nth frame is input, the pixel shifting circuit 35 pixel-shifts image data of four partial regions, which are located at the first row −1 pixel in the X direction as shown in FIG. 7. The pixel thinning-out circuit 36 performs a pixel reduction process. Thus, the reduced images are stored in the memory 37. In the same manner, the pixel shifting circuit 35 pixel-shifts image data of four partial regions, which are located at the second row, +3 pixels in the X direction. The pixel thinning-out circuit 36 performs the pixel reduction. Thus, the reduced images are stored in the memory 37. In the same manner as described above, reduced image data of the Nth frame, which is obtained by performing the pixel shifting and the pixel thinning-out process, is stored in the memory 37.

When an image of the (N+1)th frame is input, as described above with reference to FIG. 8, reduced image data obtained by pixel-shifting in the Y direction and the pixel thinning-out process is stored in the memory 40. When the reduced image of the four partial regions located at the first row is stored in the memory 40, a comparison operation for calculating motion vectors of the four partial regions can be performed. Accordingly, the process of calculating the motion vectors of the four partial regions is performed simultaneously and in parallel with storage of reduced images of the partial regions, which are located at the second row and rows subsequent to the second row, into the memory 40.

That is, the reference image cutting circuit 41 cuts out a reference image from each of the four partial regions within the memory 37 and outputs the cut reference images to the comparison operator 44. The comparison image cutting circuit 42 cuts out a comparison image from each of the four partial regions within the memory 40 and outputs the cut reference images to the comparison operator 44. The comparison operator 44 calculates a correlation amount, for each of the four partial regions, between the reference image and the comparison image. When the comparison operation between the reference image and one comparison image is completed, another comparison image shifted one pixel in the reduced image is requested to the comparison image cutting circuit 42.

When the position of the cutting block having the highest correlation is obtained for each partial region, a difference between the cutting block having the highest correlation and the reference image cutting block becomes a motion vector of each partial region, and the motion vector of each partial region is output to the movement amount operator 45.

After obtaining motion vectors of the four partial regions located at the first row, motion vectors of four partial regions located at the second row are obtained in parallel processes, and subsequently, motion vectors of four partial regions located at the third row and motion vectors of four partial regions located at the fourth row are obtained in the same manner. As a result, the motion vectors of the sixteen partial regions are input to the movement amount operator 45. The movement amount operator 45 calculates the motion vector between frames (images) by processing the sixteen motion vectors as will be described below and then outputs the motion vector between frames (images) to the display control device 33.

S For example, the display control device 33 reads out the image of the odd-number frame from the frame memory 32 and displays the read image of the odd-number frame on the display device 30. Then, when reading out the image of the even-number frame from the frame memory 31 and displaying the read image of the even-number frame on the display device 30, the display control device 33 displays the image of the even-number frame on the display device 30 after shifting the image of the even-number frame by using the motion vector between the frames.

When the image of the even-number frame is shifted and displayed on the display device 30, image data of a next odd-number frame is input and the odd-number frame memory 31 is rewritten. At the same time, a new reduced image, which is obtained through the pixel shifting circuit 35 and the pixel thinning-out circuit 36, of the image of the new odd-number frame is stored in the memory 37. At this time, since the frame switching signal is input to the switch circuit 43, the memory 40 is switched and connected to the reference image cutting circuit 41, and the memory 37 is switched and connected to the comparison image cutting circuit 42.

Thereafter, an image within the memory 40 becomes a reference image and an image within the memory 37 is cut out. A motion vector between images of the next frames is calculated. Then, the display control device 33 displays the next frame image on the display device 30 after shifting the next frame image by the use of the motion vector. A motion picture displayed on the display device 30 through the control described above becomes a motion picture with no camera shake.

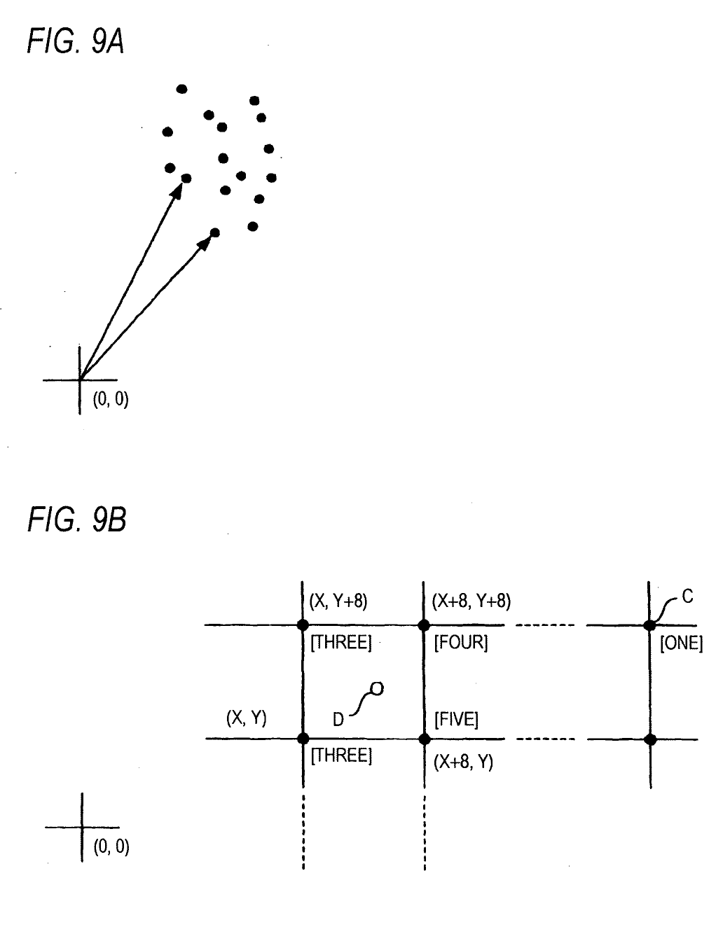

FIGS. 9A and 9B are views explaining a principle of calculating a motion vector between frames from the motion vectors of sixteen partial regions. In the case where a correlation amount is obtained by shifting a comparison image (original image) with respect to a reference image (original image) by one pixel and then a motion vector of each partial region is obtained, if errors between the motion vectors occur, the errors scatter in the unit of a pixel. This may be exemplified as shown in FIG. 9A (heads of the motion vectors are shown as points).

In contrast, in the case where a correlation amount is obtained by shifting a comparison image (original image) with respect to a reference image (original image) by one pixel in the reduced image and then a motion vector of each partial region is obtained, if errors between the motion vectors occur, the errors scatter in the unit of eight pixels on the original image. As a result, the errors shown in FIG. 9B scatter to any of the four coordinate points (X, Y), (X+8, Y), (X, Y+8), and (X+8, Y+8).

Here, in the case where an animal was moving in a certain partial region as described above, a motion vector of the certain partial region indicates a coordinate point largely apart from the four coordinate points. In the case of calculating a motion vector between frames, a motion vector indicating an abnormal value as described above is excluded. Accordingly, the motion vector between frames is calculated by using the motion vectors of the other partial regions.

In the case where there is no movement of an image in a frame, a motion vector serves only as a motion vector between frames. Accordingly, motion vectors of the respective partial regions are equal to one another. However, in the second embodiment, the reference image and the comparison image on which a comparison operation is performed in each partial region are shifted±1 pixel and ±3 pixels. Accordingly, the motion vector of each partial region scatters to four coordinate points around a point D, which is the position of an actual motion vector.

The movement amount operator 45 analyzes the sixteen motion vectors to extract only the motion vectors located at the four coordinate points (motion vector C deviating to a coordinate point other than the four coordinate points is excluded as an abnormal vector), calculates an average value of the motion vectors, which are weighted by the number of motion vectors located at each coordinate point, and calculates the obtained average value as a motion vector between frames. The calculated motion vector between frames is located within an error range of two pixels with respect to the actual motion vector shown as the point D in FIG. 9B.

### Third Embodiment

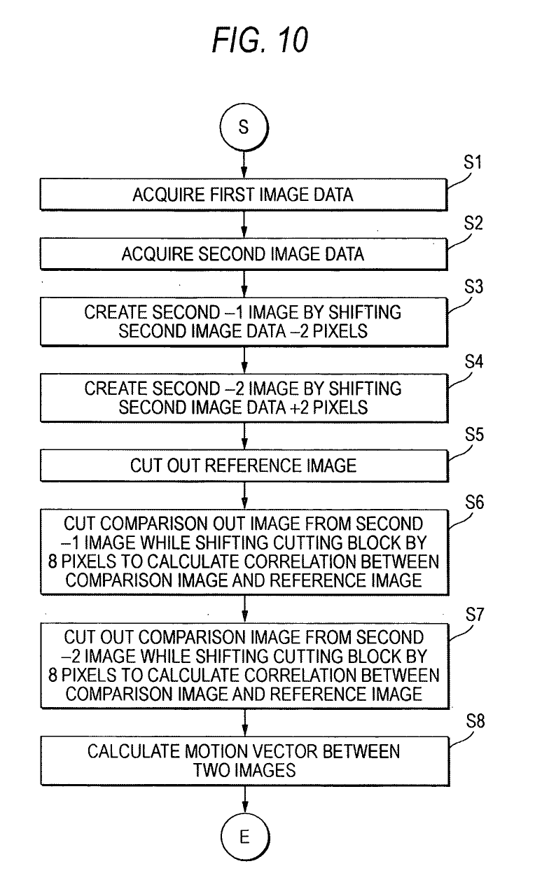

FIG. 10 is a flow chart illustrating a processing sequence of a program of calculating a motion vector between two images according to a third embodiment of the invention. Video data, which is stored in a recording medium after capturing of motion pictures with a digital camera or the like, is input to a personal computer or the like. The program of calculating a motion vector between two images is then executed by an operation processing unit of the computer. Thus, video data from which camera shake is eliminated is created.

The program of calculating a motion vector between two images according to the third embodiment causes a computer to execute the same process as that in the first embodiment described above. Specifically, the program of calculating a motion vector between two images according to the third embodiment acquires first image data from the video data, which has transferred from the recording medium to a hard (step S1). Then, the program acquires second image data from the video data (step S2). The steps S1 and S2 may be performed in parallel.

Then, second-1 image data obtained by shifting the second image data −2 pixels is created (step S3). Second-2 image data obtained by shifting the second image data +2 pixels is created (step S4). The steps S3 and S4 may be performed in parallel.

Then, a reference image is cut out from the first image data (step S5). Then, each comparison image is cut out from the second-1 image while shifting a cutting block by eight pixels, so as to calculate the correlation amount of each comparison image with respect to the reference image (step S6). Each comparison image is cut out from the 2-2 image while shifting a cutting block by eight pixels, so as to calculate the correlation amount of each comparison image with respect to the reference image (step S7). The steps S6 and S7 may be performed in parallel.

Finally, on the basis of a result of the calculations of the correlation amounts in the steps S6 and S7, a motion vector between two images is obtained (step S8).

After calculating the motion vector of the second image with respect to the first image, the steps S1 to S8 are repeated to calculate a motion vector of an image of a third image with respect to the image of the second image.

### Fourth Embodiment

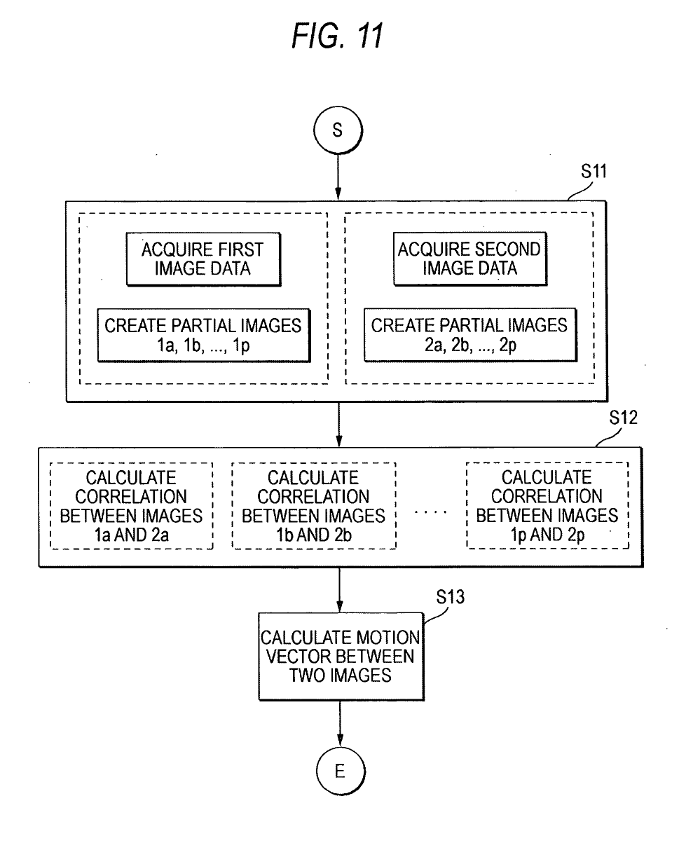

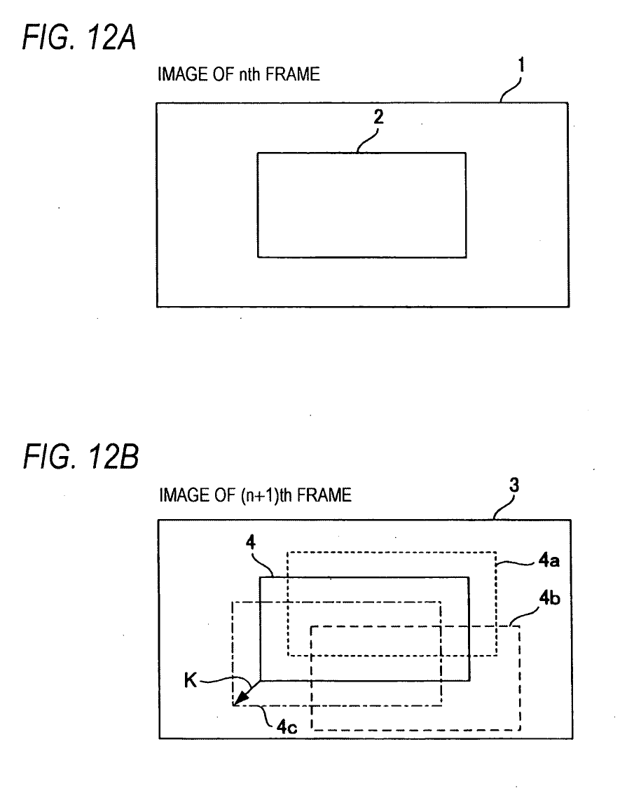

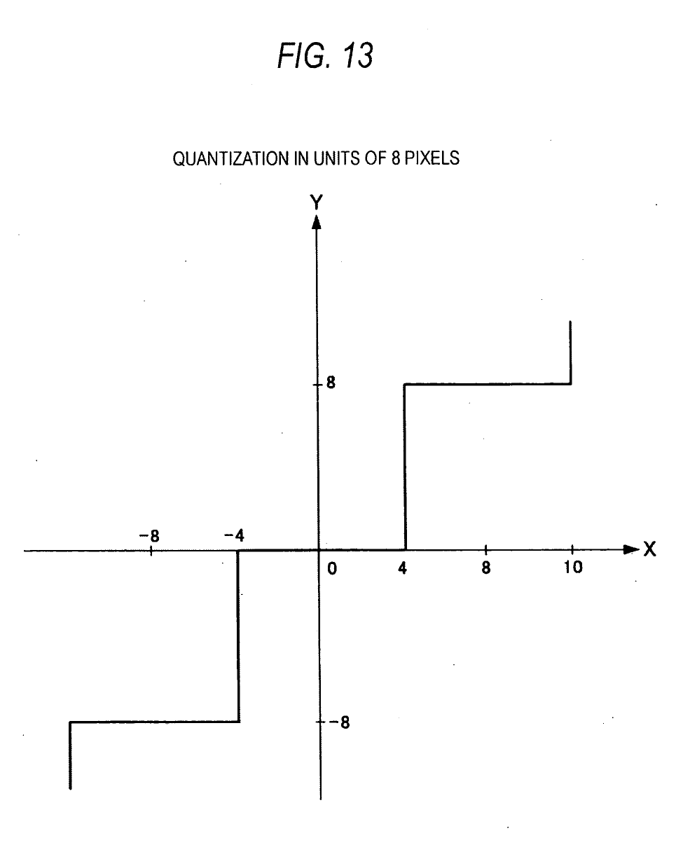

FIG. 11 is a flow chart illustrating a process sequence of a program of calculating a motion vector between two images according to a fourth embodiment of the invention. In the same manner as in the third embodiment, video data, which is stored in a recording medium after capturing of motion pictures with a digital camera, is input to a personal computer. Then, the program of calculating a motion vector between two images is used to create video data from which camera shake is eliminated.

In the fourth embodiment, the same process as in the second embodiment is performed. First, in step S11, a first image and a second image are acquired and partial images 1a, 1b, . . . , 2a, 2b, . . . are created.

The process of acquiring the first image and the second image refers to a process of reading out an image of a certain Nth frame and an image of the subsequent (N+1)th frame into a main memory of a computer from the video data, which has been transferred from a recording medium that records the video data, to a hard disk of the computer.

The process of creating the partial images 1a, 1b, . . . refers to a process of creating sixteen partial images (images shifted −1 pixel in the horizontal direction, images shifted +3 pixels in the horizontal direction, images shifted +1 pixel in the horizontal direction and images shifted −3 pixel in the horizontal direction) in total sixteen partial regions located at four rows and four columns, which are shown in FIG. 7. In addition, the process of creating the partial images 2a, 2b, . . . refers to a process of creating sixteen partial images (images shifted −1 pixel in the vertical direction, images shifted +3 pixels in the vertical direction, images shifted +1 pixel in the vertical direction and images shifted −3 pixel in the vertical direction) in total sixteen partial regions located at four rows and four columns, which are shown in FIG. 8.

Then, in step S12, an correlation operation process (a process of cutting a reference image and a comparison image out, a comparison process, or the like) is performed. In the operation process, as explained in the second embodiment, a motion vector between the partial images 1a and 2a is calculated by performing an operation regarding correlation between the partial images 1a and 2a. A motion vector between the partial images 1b and 2b is calculated by performing an operation regarding correlation between the partial images 1b and 2b. The operation process is performed on the sixteen partial regions shown in FIGS. 7 and 8.

Then, in step S13, on the basis of motion vectors of the total sixteen partial images calculated in the step S12, a process of calculating a motion vector between two images is performed by using the above method described with reference to FIGS. 9A and 9B.

After calculating the motion vector of the image of the (N+1)th frame with respect to the image of the Nth frame, the same process is repeated to calculate a motion vector of an image of an (N+2)th frame with respect to the image of the (N+1)th frame.

Moreover, even in the fourth embodiment, in the same manner as in the second embodiment, it is possible to perform the process of calculating a motion vector between two images at a high speed by setting the first image, the second image, and the partial images 1a, 1b, . . . , 2a, 2b, . . . in the step S11 as reduced image data.

In addition, in the embodiments described above, the cutting block is shifted by eight pixels. However, the invention is not limited thereto. For example, in the case of shifting the cutting block by 32 pixels, the resolution may be set to 16 pixels by using images shifted −8 pixels and +8 pixels. Further, the resolution-may be set to eight pixels by using images shifted −12 pixels, −4 pixels, +4 pixels, and +12 pixels. Alternatively, the resolution may be set to four pixels by using images shifted −14 pixels, −10 pixels, −6 pixels, −2 pixels, +2 pixels, +6 pixels, +10 pixels and +14 pixels. Alternatively, in the same manner as described above, the resolution may be set to two pixels by setting a shifting unit of an image to two pixels.

As described above, according to the first to fourth embodiments, it is possible to achieve an advantage in that a motion vector between frames is calculated at a high speed and with precision equal to or smaller than an amount of movement of the cutting block from which a comparison image is cut out.

In addition, the first to fourth embodiments have been described by using motion pictures as an example. However, the invention may be applied to a case where an image of a predetermined frame and an image of a next frame are mixed to create a still image. For example, there is a case where low sensitivity photographing and high sensitivity photographing are consecutively performed and then images of both frames are mixed to capture a still image whose dynamic range is large. Even in this case, the method described in any one of the first to fourth embodiments may be applied such that the images of both the frames do not shift from each other.

### Fifth Embodiment

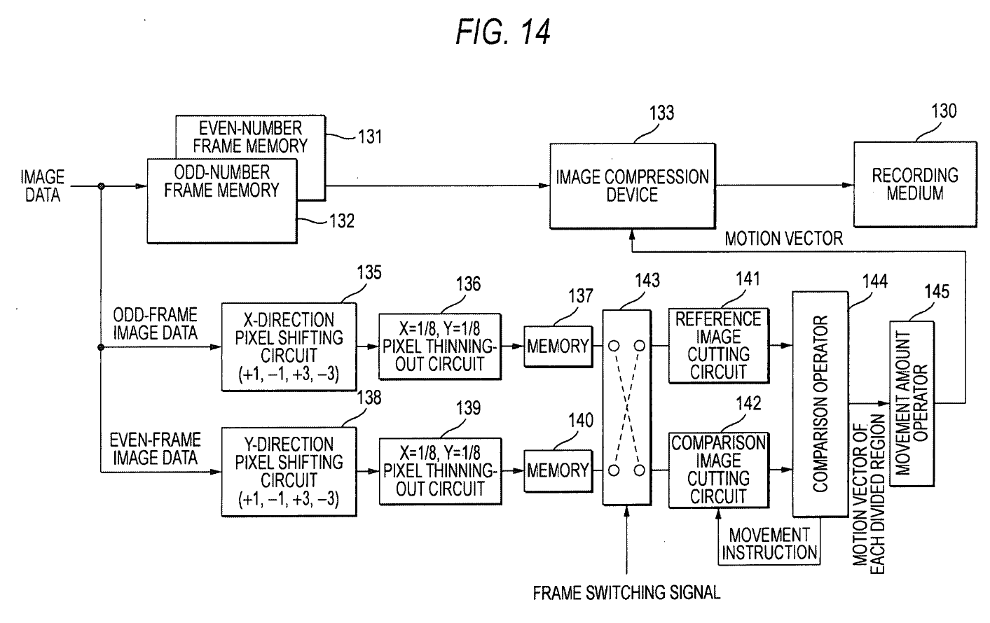

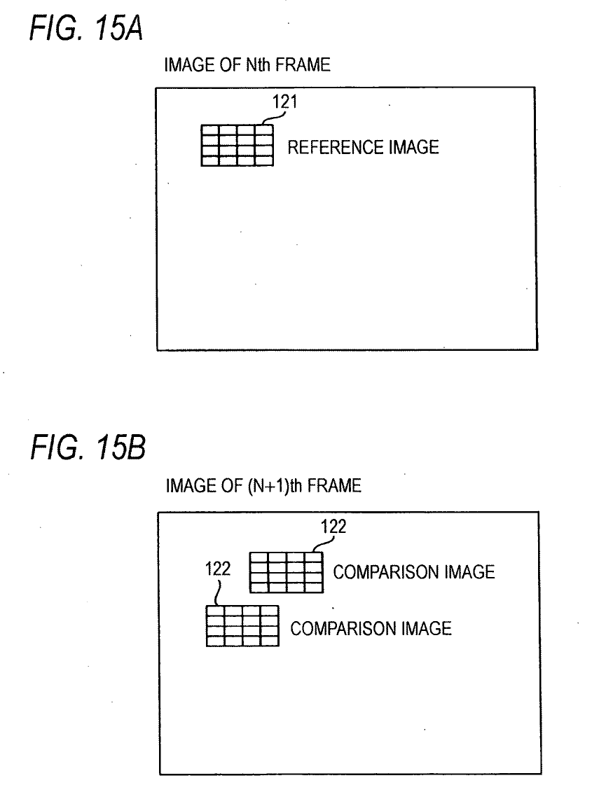

FIG. 14 is a view illustrating the functional configuration of a motion detection apparatus according to a fifth embodiment of the invention. Prior to describing the fifth embodiment shown in FIG. 14, a principle of detecting a motion according to the fifth embodiment will be explained with reference to FIGS. 15 to 19.

In the fifth embodiment, a reference image region 121 shown in FIG. 15A is compared with each comparison image region 122 shown in FIG. 15B to thereby obtain which comparison image region 122 the reference image region 121 moves to. Furthermore, in the fifth embodiment, as shown in FIGS. 15A and 15B, each of the reference image region 121 and the comparison image region 122 is divided into sixteen (=4×4) divided regions. A reference image (partial reference image) in a divided region located at an ith row and a jth column of the reference image region 121 is compared with a comparison image (partial comparison image) in a divided region located at an ith row and a jth column of the comparison image region 122. A motion vector of the entire comparison image region 122 is calculated on the basis of sixteen partial motion vectors of the respective divided regions.

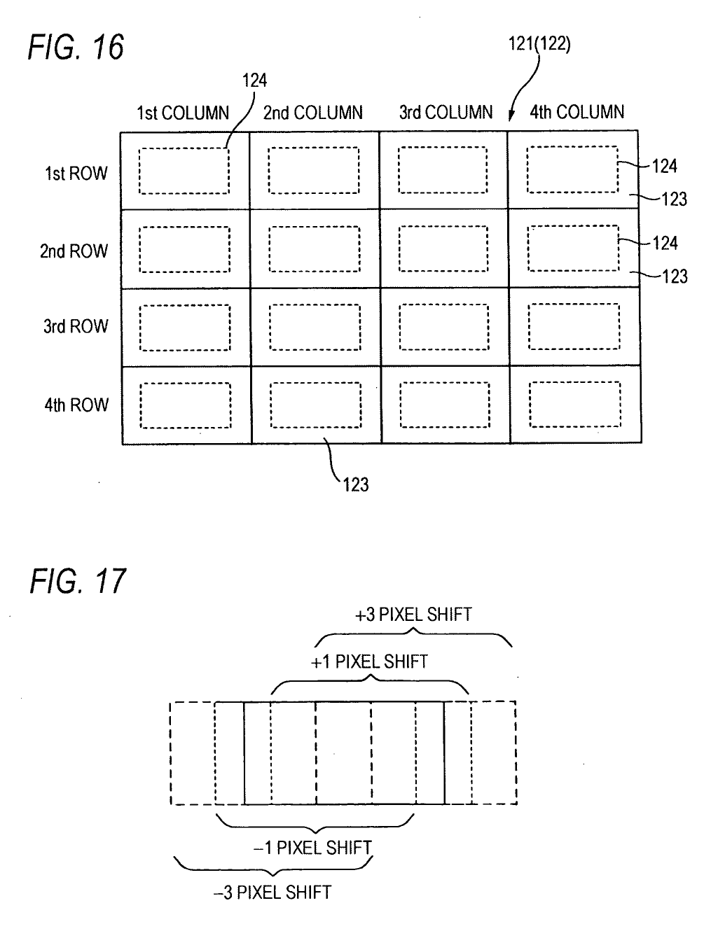

FIG. 16 is an enlarged view illustrating the reference image region 121 and the comparison image region 122. Each of the ranges 121 and 122 is divided into sixteen (=4×4) divided regions 123. A cutting region 124 from which the reference image (partial reference image) or the comparison image (partial comparison image) is actually cut out is set in each of the divided regions 123. In addition, the partial comparison image is cut out while moving the cutting region 124, from which the partial comparison image is cut out, in the divided region 123 (that is, a search range using each cutting region 124 is set to be within the divided region 123 to which each cutting region 124 belongs). Therefore, a partial motion vector of each divided region 123 is calculated.

In the first embodiment described above, the comparison image cutting block shifts by eight pixels, an image shifted −2 pixels and an image shifted +2 pixels are stored in the memories, and the resolution of a motion vector to be obtained is set to four pixels. By storing images, which are shifted −1 pixel, −3 pixels, +1 pixel, and +3 pixels in the horizontal direction, in memories by the use of the method described above, the resolution in the horizontal direction can be set to two pixels as shown in FIG. 17. In the same manner, although not shown, when shifting images −1 pixel, −3 pixels, +1 pixel and +3 pixels in the vertical direction, the resolution in the vertical direction can be set to two pixels. The fifth embodiment calculates a motion vector having a resolution of two pixels in both the vertical direction and the horizontal direction.

In the fifth embodiment, four images are created from an image of an Nth frame and are then stored in a memory. Also, four images are created from an image of an (N+1)th frame and are then stored in a memory. The four images created from the image of the Nth frame are four images shifted −1 pixel, −3 pixels, +1 pixel and +3 pixels in the horizontal direction, respectively. The four images created from the image of the (N+1)th frame are four images shifted −1 pixel, −3 pixels, +1 pixel and +3 pixels in the vertical direction, respectively.

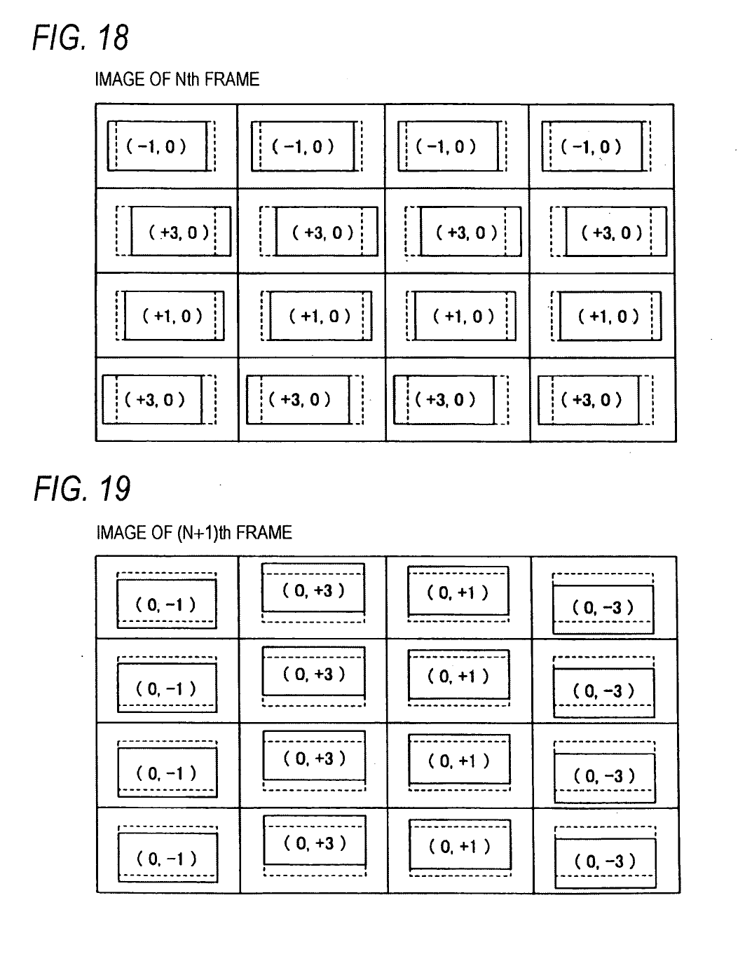

Furthermore, as shown in FIG. 18, when setting the reference image region 121 in the image of the Nth frame, a reference image in each of the divided regions located at a first row is cut out from an image shifted −1 pixel in the horizontal direction, a reference image in each of the divided regions located at a second row is cut out from an image shifted +3 pixels in the horizontal direction, a reference image in each of the divided regions located at a third row is cut out from an image shifted +1 pixel in the horizontal direction, and a reference image in each of the divided regions located at a fourth row is cut out from an image shifted −3 pixel in the horizontal direction.

Furthermore, as shown in FIG. 19, when setting the comparison image region 122 in the image of the (N+1)th frame, a comparison image in each of the divided regions located at a first column is cut out from an image shifted −1 pixel in the vertical direction, a comparison image in each of the divided regions located at a second column is cut out from an image shifted +3 pixels in the vertical direction, a comparison image in each of the divided regions located at a third column is cut out from an image shifted +1 pixel in the vertical direction, and a comparison image in each of the divided regions located at a fourth column is cut out from an image shifted −3 pixel in the vertical direction.

For example, a reference image is cut out from a central block (block shown by a dotted line) in the divided region located at the first row and the first column shown in FIG. 18 and a comparison image to be compared with the reference image is cut out from a cutting block (block shown by a dotted line) shown at a central part of the divided region located at the first row and the first column shown in FIG. 19. Then, a comparison operation between the reference image and the comparison image is performed. After the comparison operation, the comparison image cutting block 124 is shifted by eight pixels in the horizontal direction or the vertical direction. Then, the process of comparing the reference with the comparison image and shifting the cutting block 124 eight pixels is repeated. Thus, a position of a cutting block 124 from which a comparison image having the highest correlation to the reference image is cut out is obtained. Then, a motion vector in the partial region located at the first row and the first column is obtained.

For the divided region located at the first row and the second column, the comparison operation is performed in the same manner as described above so as to obtain a motion vector of the divided region located at the first row and the second column. In this manner, a motion vector of each of the sixteen divided regions is obtained. Then, a motion vector of the entire comparison image region 122 is calculated after obtaining the sixteen motion vectors.

The motion vector of each divided region calculated as described above has only. resolution of eight pixels. However, since comparison images in the respective divided regions are slightly shifted, a motion vector having a resolution of two pixels can be obtained by averaging the motion vectors of the sixteen divided regions.

After calculating the motion vector of each divided region of the image of the (N+1)th frame with respect to the corresponding divided region of the image of the Nth frame, a motion vector of each divided region of an image of an (N+2)th frame with respect to the corresponding divided region of the image of the (N+1)th frame is calculated in the same manner as described above. In this case, the image shown in FIG. 19 becomes an image from which a reference image is cut out, and the image shown in FIG. 18 becomes an image from which a comparison image is cut out.

Hereinafter, the fifth embodiment shown in FIG. 14 will be described. The motion detection apparatus according to the fifth embodiment is mounted in, for example, a digital camera that analyzes sequentially input motion pictures and compresses the motion pictures on the basis of MPEG.

The digital still camera includes a recording medium 130 that records video data, two frame memories 131 and 132 that store captured image data while alternately rewriting an even-number frame image and an odd-number frame image of the captured image data, and an image compression device 133 that reads and compresses the image data stored in the frame memories 131 and 132 and stores the compressed image data in the recording medium 130.

The motion detection apparatus, which is mounted in the digital still camera shown in FIG. 14, according to the fifth embodiment acquires input image data stored in the frame memories 131 and 132 in parallel, calculates the movement vector of the image of the (N+1)th frame with respect to the image of the Nth frame in each region, and outputs the calculated motion vector of each region, to the image compression device 133.

The motion detection apparatus includes a pixel shifting circuit 135 that is input with image data of an odd-number frame and then pixel-shifts the image data (shifts −1 pixel, +3 pixels, +1 pixel and −3 pixels as described above) in the X direction, a pixel thinning-out circuit 136 that reduces the image data output from the pixel shifting circuit 135 to ⅛ in both the X and Y directions, and a memory 137 that stores thinned image data of the odd-number frame.

In addition, the motion detection apparatus includes a pixel shifting circuit 138 that is input with image data of an odd-number frame and pixel-shifts the image data (shifts −1 pixel, +3 pixels, +1 pixel and −3 pixels as described above) in the Y direction, a pixel thinning-out circuit 139 that reduces the image data output from the pixel shifting circuit 138 to ⅛ in both the X and Y directions, and a memory 140 that stores thinned image data of the odd-number frame.

In the fifth embodiment, the pixel thinning-out circuits 136 and 139 are provided so as to thin out the pixels to ⅛ in the X and Y directions. Moving a cutting block on an original image by eight pixels corresponds to moving the cutting block on a reduced image by one pixel. In addition, reduced images are used as both the comparison image and the reference image. Accordingly, it is possible to reduce a load in the comparison operation performed for each pixel, to shorten the processing time, and to reduce the capacity of the memories 137 and 139. Here, the reduction in the vertical and horizontal directions may not be necessarily performed at the same magnification, and the reduction may be performed in only the vertical direction or in only the horizontal direction.

Furthermore, the motion detection apparatus includes: a reference image cutting circuit 141 that cuts out a reference image by means of a predetermined block; a comparison image cutting circuit 142 that cuts out a comparison image by means of the cutting block; a switch circuit 143 that switches connection between the memories 137 and 140 and the cutting circuits 141 and 142 based on a frame switching signal; a comparison operator 144 that performs a comparison operation between the reference image and the comparison image so as to calculate a motion vector of each divided region after receiving image data output from the cutting circuits 141 and 142 and outputs to the comparison image cutting circuit 142 a command for shifting the position of the cutting block; and a movement amount operator 145 that calculates a motion vector of the entire comparison image region 122 from the motion vectors of the respectively divided regions and outputs the calculated motion vector of the entire comparison image region 122 to the image compression device 133.

In the motion detection apparatus having the configuration described above, as described with reference to FIG. 18, when an image of an Nth frame is input, the pixel shifting circuit 135 creates four images obtained by shifting the image of the Nth frame±1 pixel and ±3 pixels in the X direction (horizontal direction). The pixel thinning-out circuit 136 performs a pixel reduction process on the four images. Thus, the four reduced images are stored in the memory 137.

When an image of an (N+1)th frame is input, as described with reference to FIG. 19, the pixel shifting circuit 138 creates four images obtained by shifting the image of the (N+1)th frame ±1 pixel and ±3 pixels in the Y direction (vertical direction). The pixel thinning-out circuit 139 creates four reduced images. Thus, the four reduced images are stored in the memory 140.

After reduced images of four divided regions located at the first row are stored in the memory 140, comparison operations between the reduced images of the four divided regions and the reference images are performed in parallel. That is, the reference image cutting circuit 141 cuts out the reference image from each of the four divided regions in the memory 137 and outputs the cut reference image to the comparison operator 144. The comparison image cutting circuit 142 cuts out the comparison image from each of the four divided regions in the memory 140 and outputs the cut comparison image to the comparison operator 144. The comparison operator 144 calculates a correlation amount, of each of the four divided regions, between the reference image and the comparison image. When a comparison operation between the reference image and one comparison image is completed, another comparison image shifted one pixel in the reduced image is requested to the comparison image cutting circuit 142.

When the position of the cutting block, from which a comparison image having a highest correlation with respect to the reference image is cut out, is obtained for each divided region, a difference between the position of the cutting block and the reference image cutting block in each divided region becomes a partial motion vector in the divided region. The partial motion vector is output to the movement amount operator 145.

After obtaining the motion vectors of the four divided regions located at the first row, motion vectors of four divided regions located at the second row are obtained in parallel processes. Subsequently, motion vectors of four divided regions located at the third row and motion vectors of four divided regions located at the fourth row are obtained in the same manner. As a result, the partial motion vectors of the sixteen divided regions are input to the movement amount operator 145. The movement amount operator 145 calculates a motion vector of the entire comparison image region 122 by processing the sixteen partial motion vectors and then, outputs the motion vector of the entire comparison image region 122 to the image compression device 133.

The image compression device 133 completes a compression process on an image of an even-number frame and then performs a compression process on an image of an odd-number frame. At this time, the odd-number frame memory 131 is rewritten and a new reduced image, which is obtained through the X-direction pixel shifting circuit 135 and the pixel thinning-out circuit 136, corresponding to an image of an odd-number frame is stored in the memory 137. At this time, since the frame switching signal is input to the switch circuit 143ˆthe memory 140 is switched and connected to the reference image cutting circuit 141 and the memory 137 is switched and connected to the comparison image cutting circuit 142.

Thereafter, an image in the memory 140 becomes a reference image and an comparison image is cut out from an image stored in the memory. Thus, a motion vector of each partial (divided) region of a next frame image is calculated.

### Sixth Embodiment

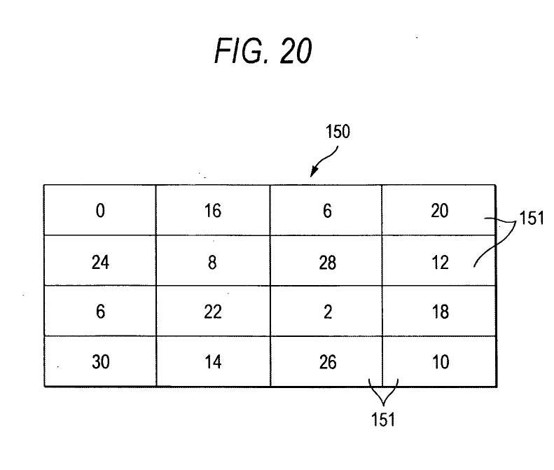

FIG. 20 is a view illustrating dividing of the cutting block and an amount of pixel shifting according to the sixth embodiment of the invention. In the first to fifth embodiments described above, the cutting block has been shifted by eight pixels. However, the invention is not limited thereto.

A dither method has been known as a technique of expressing more abundant gradations by using a predetermined small number of gradations. In the sixth embodiment, the resolution of a motion vector is enhanced by using the dither method.

FIG. 20 illustrates an example of using a Bayer-type organized dither pattern. In this example, a comparison image cutting block 150 that shifts by 32 pixels is divided into sixteen (=4×4) partial blocks 151. An image cut out from each of the partial blocks 151 is a partial comparison image. Partial comparison images are shifted in the unit of two pixels. Values attached to the respective partial blocks 151 in FIG. 20 denote the number of pixels which the partial blocks 151 are shifted in the X direction.

Moreover, in the same manner as described above, the reference image cutting block is also divided into sixteen (=4×4) partial blocks. A partial reference image cut out from each partial block of a reference image, which is not shifted, is compared with a partial comparison image cut out from the partial block 151 shown in FIG. 20. Thus, partial motion vectors of the respective partial blocks are obtained. Then, a motion vector at the position of the entire cutting block 150 is obtained by averaging the partial motion vectors.

Furthermore, the example has been described on the assumption that the reference image is not pixel-shifted but that the comparison image is pixel-shifted. However, the example may be applied to an opposite case in the same manner.

In the dither method of visually raising the density gradation, a threshold value of gradation is modulated to improve the precision of gradation. However, in the case of applying the dither method to detect an amount of movement, it is preferable to modulate the cutting block or a center of an image as shown in FIG. 20. In the example described above, a shift amount of the center is ‘dither value −1’ taking into consideration that an actual center shifts from a center of a mixed vector. That is, the shift amount of the center is −1×[half of minimum shift amount (two pixels in the example shown in FIG. 10)].

In addition, in the embodiment shown in FIG. 20, only the shift amount in the X direction is shown to increase the resolution in the X direction. In order to increase the resolution in the Y direction, pixel shifting in the Y direction needs to be performed in the same manner as described above. In addition, in order to increase the resolution in both the X and Y directions, a partial cutting block for which the pixel shifting in the X direction is performed and a partial cutting block for which the pixel shifting in the Y direction is performed are preferably mixed.

As described above, according to the fifth and sixth embodiments, it is possible to achieve an advantage in that a motion vector, which is obtained by motion detection, is calculated at a high speed and with precision equal to or smaller than an amount of movement of the cut block from which a comparison image is cut out.

In the method and device for calculating a motion vector between two images and the program of calculating a motion vector between two images according to the embodiments of the invention, a process of calculating high-density motion vectors can be performed at a high speed. Thus, the method and device for calculating a motion vector between two images and the program of calculating a motion vector between two images according to the embodiments of the invention may be effectively applied to a digital camera having a video recording function or a digital camera that mixes two images to create one image and is useful to cause a computer to execute an image captured by a digital camera or the like at a high speed.

What is claimed is:

1. A method of calculating a motion vector between two images, the method comprising:
cutting out a reference image from a first image with a reference image cutting block;
shifting a second image by m pixels and storing a plurality of the shifted second images in a memory;
cutting out comparison images from the shifted second images while shifting a comparison image cutting block by n pixels wherein 2≦n, m<n and the comparison image cutting block has the same size as the reference image cutting block;
performing operations of calculating correlations between the reference image and the respective comparison images cut out from the respective shifted second images in parallel; and
calculating a motion vector of the second image with respect to the first image based on a position of the comparison image cutting block, from which a comparison image having the highest correlation to the reference image is cut out, and a position of the reference image cutting block.

2. A method of calculating a motion vector between two images, the method comprising:
dividing a first image into a predetermined number of first partial images;
dividing a second image into second partial images wherein number of the second partial images is equal to the predetermined number, and the first partial images are equal in size to the second partial images;
shifting the plurality of second partial images by different numbers of pixels wherein the different numbers are smaller than n;
storing the shifted second partial images in a memory;
cutting out a reference image from each of the first partial images with reference image cutting blocks;
cutting out a plurality of comparison images from the shifted second partial images with comparison image cutting blocks while shifting the comparison image cutting blocks by n pixels wherein the comparison image cutting blocks are equal in size to the reference image cutting blocks;
calculating correlations between the plurality of comparison images, which are cut out from the shifted second partial images, and the reference images cut out from the corresponding first partial images;
calculating a motion vector of each of the second partial images with respect to the corresponding first partial image based on a position of the comparison image cutting block, from which a comparison image having the highest correlation to the reference image is cut out, and the position of the reference image cutting block; and
calculating a motion vector of the second image with respect to the first image based on the motion vectors of the plurality of second partial images.

3. The method according to claim 2, further comprising:
shifting the plurality of first partial images by different numbers of pixels wherein the different numbers are smaller than n; and
storing the shifted first partial images in a memory, wherein:
the cutting of the reference image from each first partial image cuts out the reference image from each shifted first partial images.

4. The method according to claim 2, wherein:
the calculating of the motion vector of the second image with respect to the first image comprises:
excluding a motion vector showing an abnormal value from the motion vectors of the plurality of second partial images; and
weight-averaging the motion vectors of the remaining second partial images.

5. The method according to claim 1, further comprising:
acquiring the first image and the second image subsequently as successive frame images; and
after the motion vector of the second image with respect to the first image is calculated, when a third image is acquired as a next frame,
cutting out the reference image from the second image with the cutting block;
shifting the third image by m pixels and storing a plurality of the shifted second images in the memory;
cutting out the comparison images from the shifted third images while shifting the comparison image cutting block by n pixels;
performing operations of calculating correlations between the reference image and the respective comparison images cut out from the respective shifted third images in parallel; and
calculating a motion vector of the third image with respect to the second image based on a position of the comparison image cutting block, from which a comparison image having the highest correlation to the reference image is cut out, and a position of the reference image cutting block.

6. The method according to claim 1, further comprising:
reducing the plurality of shifted second images at a predetermined magnification in at least one of a vertical direction and a horizontal direction, wherein:
the storing of the shifted second images stores the reduced second images in the memory,
the cutting out of the comparison images cuts out the comparison images from the reduced second images while shifting the comparison image cutting block, which is reduced at the predetermined magnification, by one pixel, and
the cutting out of the reference image cuts out the reference image from the first image, which is reduced at the predetermined magnification.

7. The method according to claim 6, wherein the reducing of the shifted second images reduces the plurality of shifted second images to 1/n in the vertical and horizontal directions.

8. An apparatus for calculating a motion vector between two images, the apparatus comprising:
a reference image cutting circuit that cuts out a reference image from a first image with a reference image cutting block;
a comparison image cutting circuit that cuts out comparison images from shifted second images, which are obtained by shifting a second image by m pixels, while shifting a comparison image cutting block by n pixels wherein 2≦n, m<n and the comparison image cutting block has the same size as the reference image cutting block;
a comparison operation circuit that performs operations of calculating correlations between the reference image and the respective comparison images cut out from the respective shifted second images in parallel; and
a movement amount operation circuit that calculates a motion vector of the second image with respect to the first image based on a position of the comparison image cutting block, from which a comparison image having the highest correlation to the reference image is cut out, and a position of the reference image cutting block.

9. An apparatus for calculating a motion vector between two images, the apparatus comprising:
a first shifting circuit that divides a first image into a predetermined number of first partial images;
a second shifting circuit that divides a second image into second partial images and shifts the plurality of second partial images by different numbers of pixels wherein number of the second partial images is equal to the predetermined number, the first partial images are equal in size to the second partial images, and the different numbers are smaller than n;
a memory that stores the shifted second partial images;
a first cutting circuit that cuts out a reference image from each of the first partial images with a reference image cutting block;
a second cutting circuit that cuts out a plurality of comparison images from the shifted second partial images with comparison image cutting blocks while shifting the comparison image cutting blocks by n pixels wherein the comparison image cutting blocks are equal in size to the reference image cutting blocks;
a first operator that calculates correlations between the plurality of comparison images, which are cut out from the shifted second partial images, and the reference images cut out from the corresponding first partial images and that calculates a motion vector of each of the second partial images with respect to the corresponding first partial image based on a position of the comparison image cutting block, from which a comparison image having the highest correlation to the reference image is cut out, and the position of the reference image cutting block; and
a second operator that calculates a motion vector of the second image with respect to the first image based on the motion vectors of the plurality of second partial images.

10. The apparatus according to claim 9, wherein:
the first shifting circuit shifts the plurality of first partial images by different number of pixels, and
the different numbers are smaller than n,
the apparatus further comprising:
another memory that stores the shifted first partial images, wherein:
the first cutting block cuts out the reference image from each of the shifted first partial images.

11. The apparatus according to claim 9, wherein:
the second operator excludes a motion vector showing an abnormal value from the motion vectors of the plurality of second partial images and weight-averages the motion vectors of the remaining second partial images to calculate the motion vector of the second image with respect to the first image.

12. The apparatus according to claim 8, wherein:
after the first and second images are subsequently input to the apparatus as successive frame images and the movement amount operation circuit calculates the motion vector of the second image with respect to the first image, when a third image is input to the apparatus as a next frame image,
the reference image cutting circuit cuts out the reference image from the second image with the reference image cutting block,
the comparison image cutting circuit cuts out comparison images from shifted third images, which are obtained by shifting third image by m pixels, while shifting the comparison image cutting block by n pixels,
the comparison operation circuit performs operations of calculating correlations between the reference image and the respective comparison images cut out from the respective shifted third images in parallel, and
the movement amount operation circuit calculates a motion vector of the third image with respect to the second image based on a position of the comparison image cutting block, from which a comparison image having the highest correlation to the reference image is cut out, and a position of the reference image cutting block.

13. The apparatus according to claim 8, further comprising:
a pixel thinning-out circuit that reduces the plurality of shifted second images at a predetermined magnification in at least one of a vertical direction and a horizontal direction, wherein:
the reduced second images are stored in a memory,
the comparison image cutting circuit cuts out the comparison images from the reduced second images while shifting the comparison image cutting block, which is reduced at the predetermined magnification, by one pixel, and
the reference image cutting circuit cuts out the reference image from the first image, which is reduced at the predetermined magnification.

14. The apparatus according to claim 13, wherein the pixel thinning-out circuit reduces the plurality of shifted second images to 1/n in the vertical and horizontal directions.

15. A computer-readable medium that stores a program causing a computer to execute a process for calculating a motion vector between two images, the process comprising:
cutting out a reference image from a first image with a reference image cutting block;
shifting a second image by m pixels and storing a plurality of the shifted second images in a memory;
cutting out comparison images from the shifted second images while shifting a comparison image cutting block by n pixels wherein 2≦n, m<n and the comparison image cutting block has the same size as the reference image cutting block;
performing operations of calculating correlations between the reference image and the respective comparison images cut out from the respective shifted second images in parallel; and
calculating a motion vector of the second image with respect to the first image based on a position of the comparison image cutting block, from which a comparison image having the highest correlation to the reference image is cut out, and a position of the reference image cutting block.

16. A computer-readable medium that stores a program causing a computer to execute a process for calculating a motion vector between two images, the process comprising:
dividing a first image into a predetermined number of first partial images;
dividing a second image into second partial images wherein number of the second partial images is equal to the predetermined number, and the first partial images are equal in size to the second partial images;
shifting the plurality of second partial images by different numbers of pixels wherein the different numbers are smaller than n;
storing the shifted second partial images in a memory;
cutting out a reference image from each of the first partial images with reference image cutting blocks;
cutting out a plurality of comparison images from the shifted second partial images with comparison image cutting blocks while shifting the comparison image cutting blocks by n pixels wherein the comparison image cutting blocks are equal in size to the reference image cutting blocks;
calculating correlations between the plurality of comparison images, which are cut out from the shifted second partial images, and the reference images cut out from the corresponding first partial images;
calculating a motion vector of each of the second partial images with respect to the corresponding first partial image based on a position of the comparison image cutting block, from which a comparison image having the highest correlation to the reference image is cut out, and the position of the reference image cutting block; and
calculating a motion vector of the second image with respect to the first image based on the motion vectors of the plurality of second partial images.

17. The medium according to claim 16, wherein:
the process further comprises:
shifting the plurality of first partial images by different numbers of pixels wherein the different numbers are smaller than n; and
storing the shifted first partial images in a memory, and
the cutting of the reference image from each first partial image cuts out the reference image from each shifted first partial images.

18. The medium according to claim 16,
the calculating of the motion vector of the second image with respect to the first image comprises:
excluding a motion vector showing an abnormal value from the motion vectors of the plurality of second partial images; and
weight-averaging the motion vectors of the remaining second partial images.

19. The medium according to claim 15, wherein: the process further comprises:
acquiring the first image and the second image subsequently as successive frame images; and
after the motion vector of the second image with respect to the first image is calculated, when a third image is acquired as a next frame,
cutting out the reference image from the second image with the cutting block;
shifting the third image by m pixels and storing a plurality of the shifted second images in the memory;
cutting out the comparison images from the shifted third images while shifting the comparison image cutting block by n pixels;
performing operations of calculating correlations between the reference image and the respective comparison images cut out from the respective shifted third images in parallel; and
calculating a motion vector of the third image with respect to the second image based on a position of the comparison image cutting block, from which a comparison image having the highest correlation to the reference image is cut out, and a position of the reference image cutting block.

20. The medium according to claim 15, wherein:
the process further comprises reducing the plurality of shifted second images at a predetermined magnification in at least one of a vertical direction and a horizontal direction,
the storing of the shifted second images stores the reduced second images in the memory,
the cutting out of the comparison images cuts out the comparison images from the reduced second images while shifting the comparison image cutting block, which is reduced at the predetermined magnification, by one pixel, and
the cutting out of the reference image cuts out the reference image from the first image, which is reduced at the predetermined magnification.

21. The medium according to claim 20, wherein the reducing of the shifted second images reduces the plurality of shifted second images to 1/n in the vertical and horizontal directions.

22. A motion detection method comprising:
cutting out a part of a first image as a reference image;
dividing the cut reference image into a plurality of partial reference regions;
cutting out a part of a second image as a comparison image, wherein the reference image is equal in size to the comparison image;
dividing the comparison image into a plurality of partial comparison regions, wherein the number of the partial reference regions is equal to the number of the partial comparison regions;
cutting out a partial reference image from each partial reference region with a partial reference image cutting block;
cutting out partial comparison images from each partial comparison region with a partial comparison image cutting block while shifting the partial comparison image cutting block by n pixels, wherein the partial reference image cutting blocks are equal in size to the partial comparison image cutting blocks;
calculating correlations between each partial reference image and the corresponding partial comparison images;
calculating a motion vector of each partial comparison region with respect to the corresponding partial reference region based on a position of the partial comparison image cutting block, from which a partial comparison image having the highest correlation to the corresponding partial reference image is cut out, and a position of the partial reference image cutting block; and
calculating a motion vector of the second image with respect to the first image based on the plurality of calculated motion vectors of the partial comparison regions with respect to the respective partial reference regions.

23. The method according to claim 22, further comprising:
shifting the first image by different numbers of pixels and storing a plurality of the shifted first images in a memory, wherein:
the different numbers are smaller than n; and
the plurality of partial reference images are cut out from the respective shifted first images.

24. The method according to claim 23, further comprising:
shifting the second image by different numbers of pixels and storing a plurality of the shifted second images in a memory, wherein:
the different numbers are smaller than n; and
the plurality of partial comparison images are cut out from the respective shifted second images.

25. The method according to claim 22, further comprising:
shifting the second image by different numbers of pixels and storing a plurality of the shifted second images in a memory, wherein:
the different numbers are smaller than n; and
the plurality of partial comparison images are cut out from the respective shifted second images.

26. The method according to claim 25, wherein a pixel shifting pattern of each partial comparison image is an organized dither pattern.

27. The method according to claim 22, further comprising:
reducing the second image at a predetermined magnification in at least one of a vertical direction and a horizontal direction; and
storing the reduced second images in a memory, wherein:
the comparison image or the partial comparison images are cut out with shifting by one-pixel on the reduced second image.

28. The method according to claim 27, wherein the reducing of the second image reduces the second image to 1/n in the vertical and horizontal directions.

29. A motion detection apparatus comprising:
a reference image cutting circuit that cuts out a part of a first image as a reference image, that divides the cut reference image into a plurality of partial reference regions and that cuts out a partial reference image from each partial reference region with a partial reference image cutting block;
a comparison image cutting circuit that cuts out a part of a second image as a comparison image, that divides the comparison image into a plurality of partial comparison regions and that cuts out partial comparison images from each partial comparison region with a partial comparison image cutting block while shifting the partial comparison image cutting block by n pixels, wherein the reference image is equal in size to the comparison image, the number of the partial reference regions is equal to the number of the partial comparison regions and the partial reference image cutting blocks are equal in size to the partial comparison image cutting blocks;
a first operator that calculates correlations between each partial reference image and the corresponding partial comparison images and that calculates a motion vector of each partial comparison region with respect to the corresponding partial reference region based on a position of the partial comparison image cutting block, from which a partial comparison image having the highest correlation to the corresponding partial reference image is cut out, and a position of the partial reference image cutting block; and
a second operator that calculates a motion vector of the second image with respect to the first image based on the plurality of calculated motion vectors of the partial comparison regions with respect to the respective partial reference regions.

30. The apparatus according to claim 29, further comprising:
a first shifting circuit that shifts the first image by different numbers of pixels; and
a first memory that stores a plurality of the shifted first images, wherein:
the different numbers are smaller than n; and
the plurality of partial reference images are cut out from the respective shifted first images.

31. The apparatus according to claim 30, further comprising:
a second shifting circuit that shifts the second image by different numbers of pixels; and
a second memory that stores a plurality of the shifted second images, wherein:
the different numbers are smaller than n; and
the plurality of partial comparison images are cut out from the respective shifted second images.

32. The apparatus according to claim 29, further comprising:
a second shifting circuit that shifts the second image by different numbers of pixels; and
a second memory that stores a plurality of the shifted second images, wherein:
the different numbers are smaller than n; and
the plurality of partial comparison images are cut out from the respective shifted second images.

33. The apparatus according to claim 31, wherein a pixel shifting pattern of each partial comparison-image is an organized dither pattern.

34. The apparatus according to claim 29, further comprising:
a pixel thinning-out circuit that reduces the second image at a predetermined magnification in at least one of a vertical direction and a horizontal direction; and
a memory that stores the reduced second images, wherein:
the comparison image or the partial comparison images are cut out with shifting by one-pixel on the reduced second image.

35. The apparatus according to claim 34, wherein the pixel thinning-out circuit reduces the second image to 1/n in the vertical and horizontal directions.
